(19) United States
(12) Patent Application Publication
(10) Pub. No.: US 2025/0306505 A1
(43) Pub. Date: Oct. 2, 2025

(54) DEVELOPING DEVICE AND DEVELOPER CONTAINER MANUFACTURING METHOD

(71) Applicant: CANON KABUSHIKI KAISHA, Tokyo (JP)

(72) Inventors: Yusuke Atsu, Kanagawa (JP); Naoki Matsumaru, Shizuoka (JP); Ryota Ooka, Shizuoka (JP)

(21) Appl. No.: 19/082,782

(22) Filed: Mar. 18, 2025

(30) Foreign Application Priority Data
Mar. 29, 2024 (JP) 2024-057811

(51) Int. Cl. G03G 15/08

(52) U.S. Cl. CPC G03G 15/0898; G03G 2215/0872

(57) ABSTRACT

A developing device includes a developing roller, a resin frame, a sealing member, a first resin sheet, and a second resin sheet. The second resin sheet is arranged with the first resin sheet in a first direction on a side downstream of the first resin sheet. The resin frame includes a bearing surface, and first to third injection port marks. The bearing surface extends in a second direction crossing the first direction on a side downstream of the second resin sheet with respect to the first direction. The first and second injection port marks are provided on a side upstream of the first resin sheet with respect to the first direction and are arranged in the second direction. The third injection port mark is provided on a side downstream of the second sheet and upstream of the bearing surface with respect to the first direction.

### FIELD OF THE INVENTION AND RELATED ART

The present invention relates to a developing device used in an image forming apparatus, such as a copying machine, a printer, a facsimile machine, or a multi-function machine having a plurality of functions of functions of these machines, using an electrophotographic type or an electrostatic recording type, and relates a developer container manufacturing method.

Conventionally, for example, the image forming apparatus such as the printer using the electrophotographic type includes the developing device for developing an electrostatic latent image, formed on an image bearing member, with a developer. The developing device includes a developer container for accommodating the developer. The developing device is made detachably mountable to an apparatus main assembly of the image forming apparatus substantially singly or in made detachably mountable as a process cartridge to the apparatus main assembly of the image forming apparatus in combination with another element.

Further, there is a method in which a remaining amount of the developer in a developer container in which the amount of the developer is decreased with image formation is detected by using a change in electrostatic capacity. The electrostatic capacity is measured by using, for example, two resin sheets having electroconductivity (hereinafter, referred to as “electroconductive sheets” provided in the developer container.

In Japanese Laid-Open Patent Application No. 2018-087967, a method in which a developer container and two electroconductive sheets for measuring the electrostatic capacity are molded integrally with each other is disclosed. In this method, in a direction in which the two electroconductive sheets are arranged, a resin is injected through two injection ports provided outside the two electroconductive sheets and thus the two electroconductive sheets are provided to the developer container by image.

### SUMMARY OF THE INVENTION

According to an aspect of the present invention, there is provided a developing device comprising: a developing roller; a resin frame constituting a developer container for accommodating a developer; a sealing member configured to seal a gap between the developing roller and the resin frame; a first resin sheet molded integrally with the resin frame and having electroconductivity; and a second resin sheet molded integrally with the resin frame and having electroconductivity, the second resin sheet being arranged with the first resin sheet in a first direction and being provided no a side downstream of the first resin sheet with respect to the first direction, wherein the resin frame includes a bearing surface for mounting the sealing member thereon, and a first injection port mark, a second injection port mark, and a third injection port mark which are marks where a resin was injected, wherein the bearing surface extends in a second direction crossing the first direction on a side downstream of the second resin sheet with respect to the first direction, wherein the first injection port mark and the second injection port mark are provided on a side upstream of the first resin sheet with respect to the first direction and are arranged in the second direction, and wherein the third injection port mark is provided on a side downstream of the second resin sheet and upstream of the bearing surface with respect to the first direction.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of the image forming apparatus in a state in which a front door is open.

FIG. 3 is a schematic sectional view of the image forming apparatus in a state in which a cartridge tray is pulled out.

FIG. 4 is a schematic sectional view of the image forming apparatus in a state in which a process cartridge is detached.

FIG. 5 is a sectional view of the process cartridge.

FIG. 6 is an exploded perspective view of a drum unit.

FIG. 7 is an exploded perspective view of a developing unit.

FIG. 8 is an assembling perspective view of the process cartridge.

FIG. 9 is a perspective view of the process cartridge.

FIG. 10 is a schematic sectional view of the developing unit.

FIG. 11 is a perspective view of a second development frame.

FIG. 12 is a sectional view of the second development frame.

FIG. 13 is a schematic view of a developer remaining amount detecting constitution.

Parts (a) and (b) of FIG. 14 are schematic sectional views of the developing unit, for illustrating conveyance of the developer toward a remaining amount detecting portion.

Parts (a) and (b) of FIG. 15 are schematic sectional views of a metal mold structure for illustrating image.

Parts (a), (b), and (c) of FIG. 16 are schematic sectional views of a metal mold structure for illustrating image.

FIG. 17 is a schematic sectional view of a metal mold structure for illustrating image.

### DESCRIPTION OF THE EMBODIMENTS

In the following, a developer container manufacturing method, a resin frame, developer container, and developing device according to the present invention will be described specifically based on embodiments with reference to the drawings. However, dimensions, materials, shapes, a relative arrangement, and the like of constituent parts described in the following embodiments should be appropriately changed depending on constitutions and various conditions of apparatuses (devices) to which the present invention is applied, and a scope of the present invention is not limited to the following embodiments.

### Embodiment 1

### <General Structure and Operation of Image Forming Apparatus>

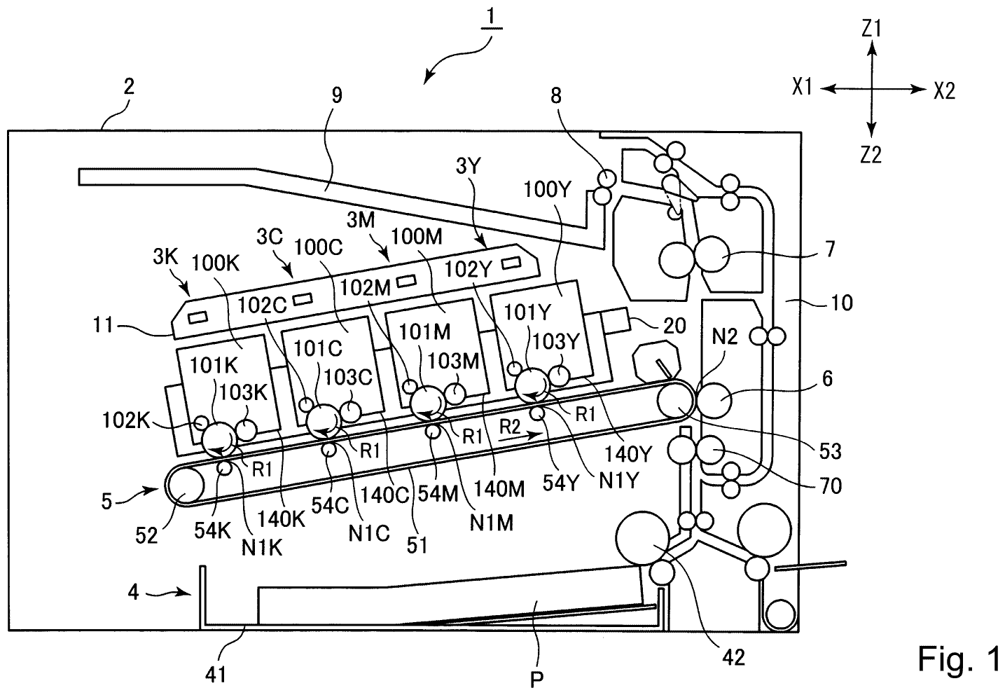

First, a general structure and an operation of an image forming apparatus in this embodiment will be described with reference to FIG. 1. FIG. 1 is a schematic sectional view of an image forming apparatus of this embodiment. The image forming apparatus 1 in this embodiment is a tandem laser beam printer which is capable of forming a full-color image on a sheet-like recording material P by utilizing an electrophotographic type, and which employs an intermediary transfer type. In addition, the image forming apparatus 1 in this embodiment employs a process cartridge type, in which process cartridges 100 (100Y, 100M, 100C, 100K) are detachably mounted to an apparatus main assembly 2 of the image forming apparatus 1 and carries out image formation. In this embodiment, the apparatus main assembly 2 of the image forming apparatus 1 is a portion excluding the process cartridges 100 (100Y, 100M, 100C, 100K) from the image forming apparatus 1. Incidentally, the recording material P is referred to as paper in some instances, but the recording material P includes a material other than paper, or a recording material formed of a material containing the material other than the paper (such as synthetic paper or a film which are formed with synthetic resin, metallized paper including a metal layer, or the like).

Here, as regards the image forming apparatus 1 and elements thereof, a right(-hand) side in FIG. 1 on which a front door 10 described later is referred to as a “front (front surface) side”, and a left(-hand) side in FIG. 1 which is an opposite side to the front side is referred to as a “rear (back) surface side”. Further, as regards the image forming apparatus 1 and the elements thereof, in the case where the image forming apparatus 1 is viewed from the front side, the right side is a “driving side” and the left side is a “non-driving side”. The driving side is a side where a drum coupling member for inputting a driving force to a photosensitive drum 101 described later and a development coupling member for inputting a driving force to a developing roller 103 described later are provided. Further, as regards the image forming apparatus 1 and the elements thereof, “upper (above)” and “lower (below)” refer to “upper (above)” and “lower (below)”, respectively, with respect to a gravitational direction (vertical direction), but are not intended to mean only “immediately upper (above)” and “immediately lower (below)”, respectively, and includes an “upper side” and a “lower side”, respectively, relative to a horizontal surface passing through an associated element or position. Further, a left-right direction in FIG. 1 connecting the front side and the rear side is an “X direction”, a direction connecting the non-driving side and the driving side and perpendicular to the drawing sheet of FIG. 1 is a “Y direction”, and a direction perpendicular to the X direction and the Y direction is a “Z direction”. The image forming apparatus 1 is disposed so that the Z direction is substantially parallel to the gravitational direction (so that each of the X direction and the Y direction is substantially parallel to a horizontal direction) and is used for image formation. Further, the Y direction is substantially parallel to rotational axis directions of the photosensitive drum 101 and the developing roller 103. In the X direction, a direction from the front side toward the rear side is an “X1 direction”, and a direction from the rear side toward the front side is an “X2 direction”. In the Z direction, a direction from the lower side toward the upper side is a “Z1 direction”, and a direction from the upper side toward the lower side is a “Z2 direction”. That is, the image forming apparatus 1 is disposed so that the Z2 direction becomes the gravitational direction. Further, in the Y direction, a direction from the non-driving side toward the driving side is a “Y1 direction”, and a direction from the driving side toward the non-driving side is a “Y2 direction”. FIG. 1 is a schematic sectional view of the image forming apparatus 1 showing a state in which a cross section (XZ plane) substantially perpendicular to the Y direction is viewed from the non-driving side, in which the front side of the drawing sheet is the non-driving side, and the rear side of the drawing sheet is the driving side.

The image forming apparatus 1 includes, as a plurality of image forming portions (stations), four image forming portions 3Y, 3M, 3C, and 3K for forming images of yellow (Y), magenta (M), cyan (C), and black (K), respectively. The four image forming portions 3Y, 3M, 3C, and 3K are provided in series along a movement direction of an image transfer surface of an intermediary transfer belt 51 described later. In this embodiment, this arrangement direction is a direction along a horizontal direction but is somewhat inclined relative to the horizontal direction in a state in which the image forming apparatus 1 is installed on a horizontal surface. Incidentally, elements having identical or corresponding functions or constitutions provided for the respective colors are collectively described by omitting suffixes Y, M, C, and K of reference numerals or symbols each showing the element for an associated one of the colors in some instances. In this embodiment, the image forming portion 3 is constituted by including the photosensitive drum 101 (101Y, 101M, 101C, 101K), a charging roller 102 (102Y, 102M, 102C, 102K), a laser scanner unit (exposure device) 11, a developing unit (developing device) 140, and the like. In this embodiment, the laser scanner unit 11 is constituted as a single unit for exposing the four photosensitive drums 101Y, 101M, 101C, and 101K to light, but may be provided for the respective photosensitive drums 101 independently of each other.

The photosensitive drum 1 which is a rotatable drum-shaped (cylindrical) photosensitive member (electrophotographic member) as an image bearing member is rotationally driven in an arrow R1 direction in FIG. 1 (clockwise direction) at a predetermined peripheral speed (process speed). A surface (outer peripheral surface) of the rotating photosensitive drum 101 is electrically charged uniformly to a predetermined potential of a predetermined polarity (negative polarity in this embodiment) by the charging roller 102 which is a roller-shaped charging member as a charging means. The charging roller 102 is provided in contact with the surface of the photosensitive drum 101 and is rotated with rotation of the photosensitive drum 101. During the charging, to the charging roller 102, by a charging power source (not shown) as a charging voltage applying portion, a predetermined charging bias (charging voltage) which is a DC voltage of the same polarity as a charge polarity (negative polarity in this embodiment) of the photosensitive drum 101 is applied. The charged surface of the photosensitive drum 101 is subjected to scanning exposure by the laser scanner unit 11 to laser light 12 depending on an image signal of a color component corresponding to an associated one of the image forming portions 3. By this, on the photosensitive drum 101, an electrostatic latent image (electrostatic image) depending on the image signal of the color component corresponding to the associated image forming portion 3 is formed.

The electrostatic latent image formed on the photosensitive drum 101 is developed (visualized) by being supplied with a developer (hereinafter, also referred to as “toner”) by the developing unit 140 as a developing means, so that a toner image (toner picture, developer image) is formed on the photosensitive drum 101. In this embodiment, the developing unit 140 uses a non-magnetic one-component developer (toner) as the developer. The developing unit 140 includes the developing roller 103 as a developer carrying member (developing member). The developing roller 103 conveys the toner toward a developing portion which is an opposing portion (contact portion) with the photosensitive drum 101 while carrying the toner. During the development, the developing roller 103 contacts the photosensitive drum 101. Further, during the development, the developing roller 103 is rotationally driven at a predetermined peripheral speed in a direction in which the surface movement direction of the photosensitive drum 101 and a surface (outer peripheral surface) movement direction of the developing roller 103 become the same (forward) direction in the developing portion. Further, during the development, to the developing roller 103, a predetermined developing bias (developing voltage) which is a DC voltage of the same polarity as the charge polarity (negative polarity in this embodiment) of the photosensitive drum 101 is applied by a developing power source (not shown) as a developing voltage applying portion. By this, the toner is supplied from the surface of the developing roller 103 to the surface of the photosensitive drum 101 depending on the electrostatic latent image on the photosensitive drum 101, so that the electrostatic latent image on the photosensitive drum 101 is developed. In this embodiment, on an exposed portion (image portion) of the surface of the photosensitive drum 101 lowered in absolute value of the potential by being exposed to light after being charged uniformly, the toner charged to the same polarity as the charge polarity (negative polarity in this embodiment) of the photosensitive drum 101 is deposited (reverse development type). In this embodiment, a normal charge polarity of the toner which is a principal charge polarity of the toner during the development is the negative polarity.

Below the four photosensitive drums 101Y, 101M, 101C, and 101K, an intermediary transfer unit 5 is provided so as to oppose these four photosensitive drums 101Y, 101M, 101C, and 101K. The intermediary transfer unit 5 includes the intermediary transfer belt 51 constituted by an endless belt as an intermediary transfer member, a driving roller 52 and a tension roller 53 which are as a plurality of stretching rollers (supporting rollers), and four primary transfer rollers 54Y, 54M, 54C, and 54K. A flexible intermediary transfer belt 51 is extended around the driving roller 52 and the tension roller 53 and is stretched under a predetermined tension. Further, on an inner peripheral surface side of the intermediary transfer belt 51, correspondingly to the photosensitive drums 101Y, 101M, 101C, and 101K, the primary transfer rollers 54Y, 54M, 54C, and 54K, respectively, which are roller-shaped primary transfer member as primary transfer means are provided. The primary transfer roller 54 presses the intermediary transfer belt 51 toward the associated photosensitive drum 101 and forms a primary transfer portion (primary transfer nip) N1 (N1Y, N1M, N1C, N1K) which is a contact portion between the photosensitive drum 101 and the intermediary transfer belt 51. In this embodiment, the photosensitive drum 101 contacts an upper surface of the intermediary transfer belt 51 at a lower surface thereof. The contact portion is the primary transfer portion N1. To the intermediary transfer belt 51, a driving force is transmitted by rotationally driving the driving roller 53, so that the intermediary transfer belt 51 is rotated (circulated and moved) in an arrow 2 direction in FIG. 1 (counterclockwise direction). The tension roller 53 and the primary transfer roller 54 are rotated with rotation of the intermediary transfer belt 51. The toner image formed on the photosensitive drum 101 is (transferred primarily transferred) onto the rotating intermediary transfer belt 51 in the primary transfer portion N1. During the primary transfer, to the primary transfer roller 54, a primary transfer bias (primary transfer voltage) which is a DC voltage of an opposite polarity (positive polarity in this embodiment) to the normal charge polarity is applied. For example, during full-color image formation, the toner images of the respective colors of yellow, magenta, cyan, and black formed on the photosensitive drums 101 are transferred superposedly onto the intermediary transfer belt 51 in an image forming region.

Incidentally, when an image forming operation is started, rotational drive of the photosensitive drums 101, rotational drive of the intermediary transfer belt 51, and drive of the laser scanner unit 11 are started. Then, in synchronism with the drive of the laser scanner unit 11, the charging of the surface of the photosensitive drum 101 by the charging roller 102 is started.

On an outer peripheral surface side, in a position opposing the driving roller 53, a secondary transfer roller 6 which is a roller-shaped secondary transfer member as a secondary transfer means is provided. The secondary transfer roller 6 is pressed toward the driving roller 53 and is contacted to the driving roller 53 through the intermediary transfer belt 51, and thus forms a secondary transfer portion (secondary transfer nip) N2 which is a contact portion between the intermediary transfer belt 51 and the secondary transfer roller 6. The secondary transfer roller 6 is rotated with the rotation of the intermediary transfer belt 51. The toner image formed on the intermediary transfer belt 51 is transferred (secondarily transferred) onto the recording material P nipped and conveyed by the intermediary transfer belt 51 and the secondary transfer roller 6 in the secondary transfer portion N2. During the secondary transfer, to the secondary transfer roller 6, a predetermined secondary transfer bias (secondary transfer voltage) which is a DC voltage of the opposite polarity (positive polarity in this embodiment) to the normal charge polarity of the toner is applied. The recording material (recording medium, transfer material, sheet) P is supplied from a feeding unit 4 provided below the intermediary transfer unit 5 toward the secondary transfer portion N2. The feeding unit 4 is constituted by a sheet (paper) feeding tray 41 in which recording materials P such as paper are stacked and accommodated, and a sheet feeding roller 42 as a feeding member, or the like. At a predetermined control timing, the recording materials P are separated and fed one by one from the sheet feeding tray 41 by the sheet feeding roller 42, and the fed recording material P is conveyed toward a registration roller pair 70 as a recording material conveying member. This recording material P is conveyed toward the secondary transfer portion N2 at a predetermined control timing by the registration roller pair 70.

The recording material P onto which the toner image is transferred is conveyed toward a fixing device 7 as a fixing means. The fixing device 7 fixes (melts, sticks) the toner image on the recording material P by heating and pressing the recording material P on which an unfixed toner image is carried. The recording material P on which the toner image is fixed is discharged (outputted) by a discharging roller pair 8 or the like as a discharging member onto a sheet discharge tray 9 as a discharging portion provided outside (upper portion) of the apparatus main assembly 2.

In this embodiment, in each of the image forming portions 3, the photosensitive drum 101, and as process means actable thereon, the charging roller 102 and the developing unit 140 integrally constitute a process cartridge 100 detachably mounted to the apparatus main assembly 2. In this embodiment, the four process cartridges 100Y, 100M, 100C and 100K are detachably mountable to the apparatus main assembly 2. The four process cartridges 100Y, 100M, 100C, and 100K have the same electrophotographic process and are different from each other in color of the toner used. Further, toner filling amounts may be different from each other between at least two process cartridges 100. To the process cartridge 100, a rotational driving force is transmitted from a driving force outputting portion (details thereof will be described later) of the apparatus main assembly 2, so that electric biases (charging bias, developing bias, remaining amount detecting bias, and the like) are supplied from controls (not shown) of the apparatus main assembly 2. Incidentally, the number of the process cartridges detachably mountable to the apparatus main assembly of the image forming apparatus is not limited to four, but may be appropriately set as needed.

### <Mounting and Demounting Constitution of Process Cartridge>

Next, mounting and demounting of the process cartridge 100 relative to the apparatus main assembly 2 in this embodiment will be described.

As shown in FIG. 1, the image forming apparatus 1 is provided with a movable cartridge tray 20 for supporting the process cartridge 100. In addition, the image forming apparatus 1 is provided with the front door 15 openable and closable for permitting mounting and demounting of the process cartridge 100 relative to the apparatus main assembly 2. In this embodiment, the front door 10 is rotatable about a rotational axis provided at a lower end portion thereof and substantially parallel to the Y direction, so that an upper end portion thereof in a closed state is opened by being moved downward, and the upper end portion is closed by being moved upward.

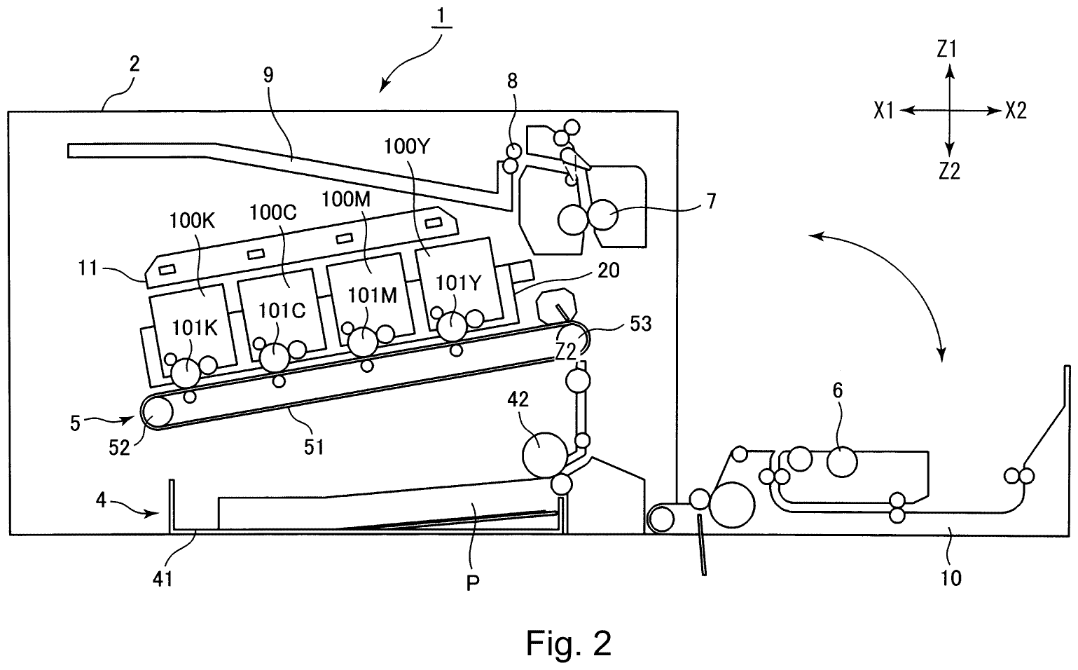

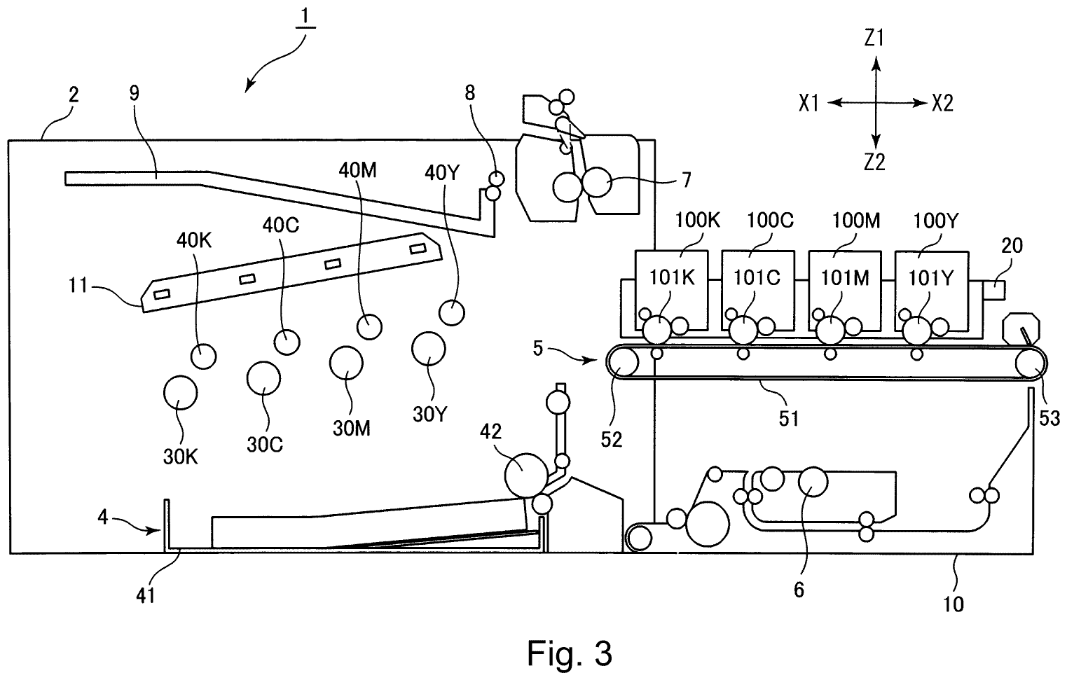

FIG. 2 is a schematic sectional view of the image forming apparatus 1 in a state in which the cartridge tray 20 is positioned inside the apparatus main assembly 2. FIG. 3 is a schematic sectional view of the image forming apparatus 1 in a state in which the cartridge tray 20 is positioned outside the apparatus main assembly 2 and in which the process cartridges 100 are accommodated in the cartridge tray 20.

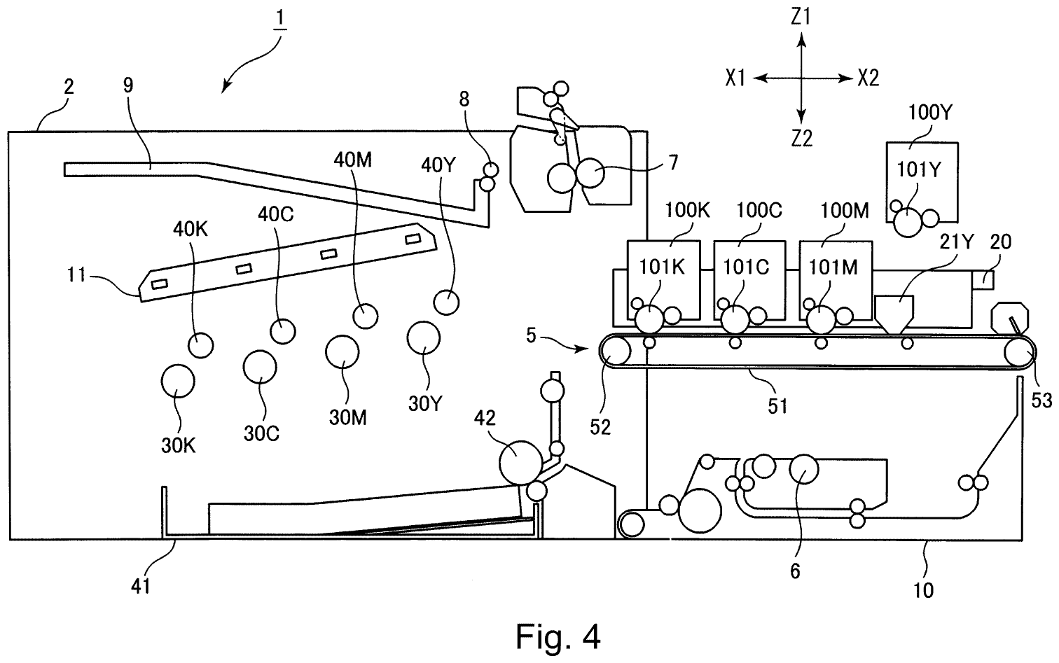

Further, FIG. 4 is a schematic sectional view of the image forming apparatus 1 in a state in which the front door 10 is open and the cartridge tray 20 is positioned outside the apparatus main assembly 2 and in which the process cartridge 100Y for yellow is demounted from the cartridge tray 20. FIGS. 2 to 4 each shows a state in which the cross section (XZ plane) substantially perpendicular to the Y direction is viewed from the non-driving side.

As shown in FIGS. 2 and 3, the cartridge tray 20 is movable in an arrow X1 direction (pushing-in direction) and in an arrow X2 direction (pulling-out direction). That is, the cartridge tray 20 is constituted, so that the cartridge tray is capable of being pulled out and pushed in relative to the apparatus main assembly 2 by being moved in a substantially horizontal direction in a state in which the apparatus main assembly 2 is disposed on the horizontal surface. Here, a state (state of FIG. 3) in which the front door 10 is open and the cartridge tray 20 is positioned outside the apparatus main assembly 2 is referred to as an “outside state”. Further, a state (state of FIG. 3) in which the front door 10 is open and the cartridge tray 20 is positioned inside the apparatus main assembly 2 is referred to as an “inside state”. In the outside state and in the inside state, each of the photosensitive drums 101 and the intermediary transfer belt 51 are separated from each other. Incidentally, in this embodiment, the intermediary transfer unit 5 is movable together with the cartridge tray 20 in the arrow X1 direction (pushing-in direction) and in the arrow X2 direction (pulling-out direction). Further, in this embodiment, the image forming apparatus 1 is constituted so that the fixing device 7 is movable in an arrow Z1 direction (upward) when a pulling-out operation and a pushing-in operation of the cartridge tray 20 (and the intermediary transfer unit 5) relative to the apparatus main assembly 2 are performed.

Further, as shown in FIG. 4, the cartridge tray 20 includes a mounting portion 21 to which each process cartridge 100 is detachably mountable in the outside state. In FIG. 4, only the mounting portion 21 for the process cartridge 100Y for yellow is illustrated, but the cartridge tray 20 similarly includes mounting portions 21 for other process cartridges 100M, 100C, and 100K.

Further, the process cartridge 100 is moved to an inside of the apparatus main assembly 2 by moving the cartridge tray 20 to the inside of the apparatus main assembly 2 in a state in which the process cartridge is mounted to the mounting portion 21. In this embodiment, the intermediary transfer unit 5 is moved (raised) in the arrow Z1 direction (upward) by a link mechanism (not shown) by closing the front door 10. By this, the intermediary transfer unit 5 is moved to a position (position where the photosensitive drum 101 and the intermediary transfer belt 51 are in contact with each other) during the image formation. Further, in this embodiment, the intermediary transfer unit 5 is moved (lowered) in an arrow Z2 direction (downward) by the link mechanism by opening the front door 10. By this, the intermediary transfer unit 5 is moved to a position where the photosensitive drum 101 and the intermediary transfer belt 51 are separated from each other.

Thus, by the cartridge tray 20, the plurality of process cartridges 100 can be moved together to a position inside the apparatus main assembly 2 where the image is capable of being formed and a position outside the apparatus main assembly 2 where each process cartridge 100 is capable of being demounted (removed).

### <General Structure of Process Cartridge>

Next, a general structure of the process cartridge 100 in this embodiment will be described.

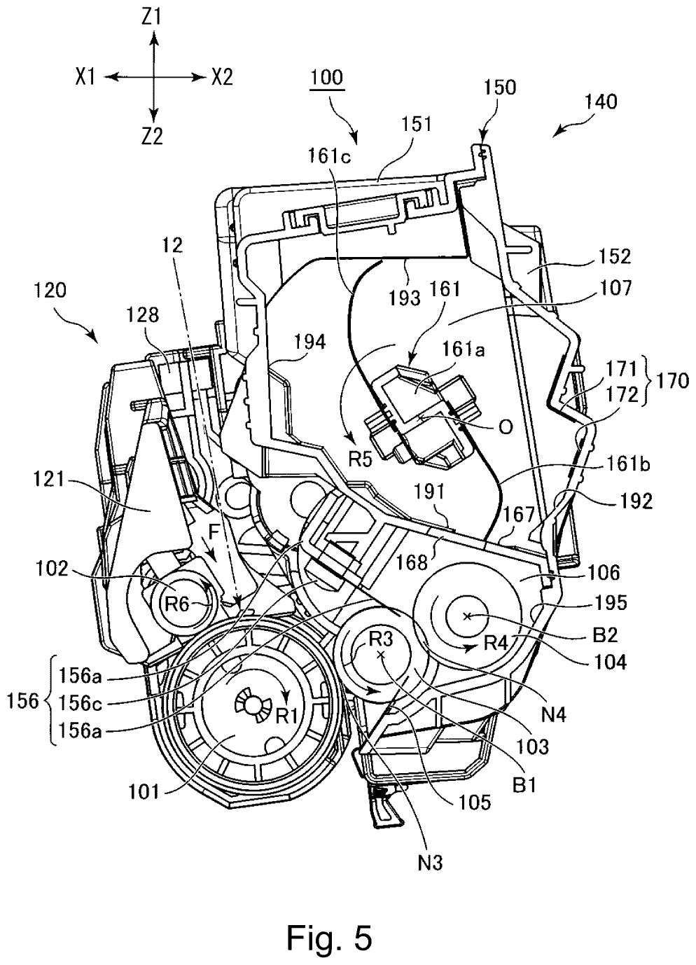

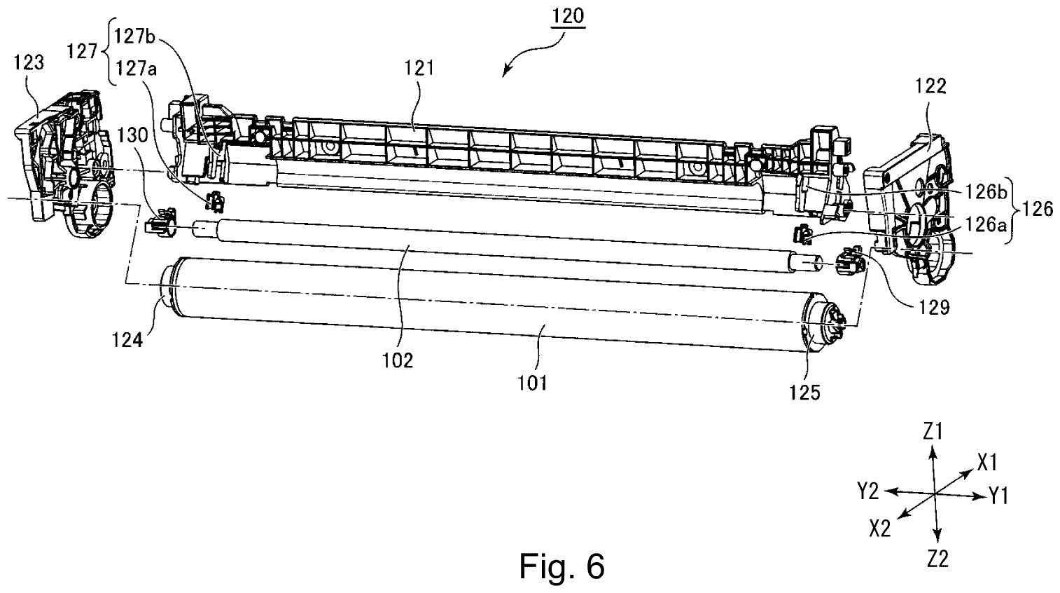

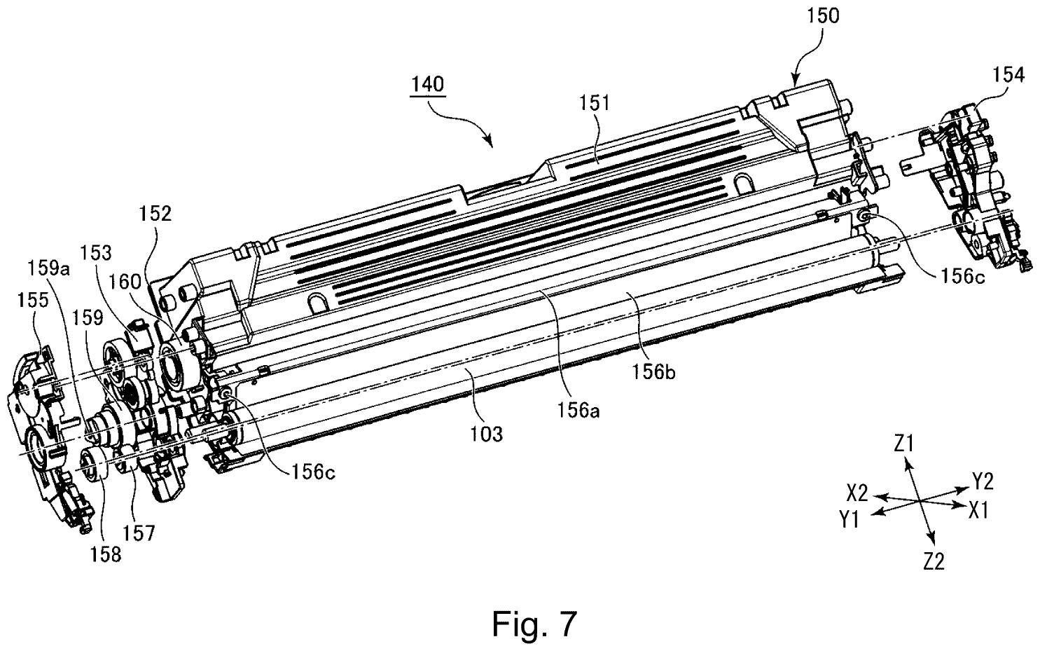

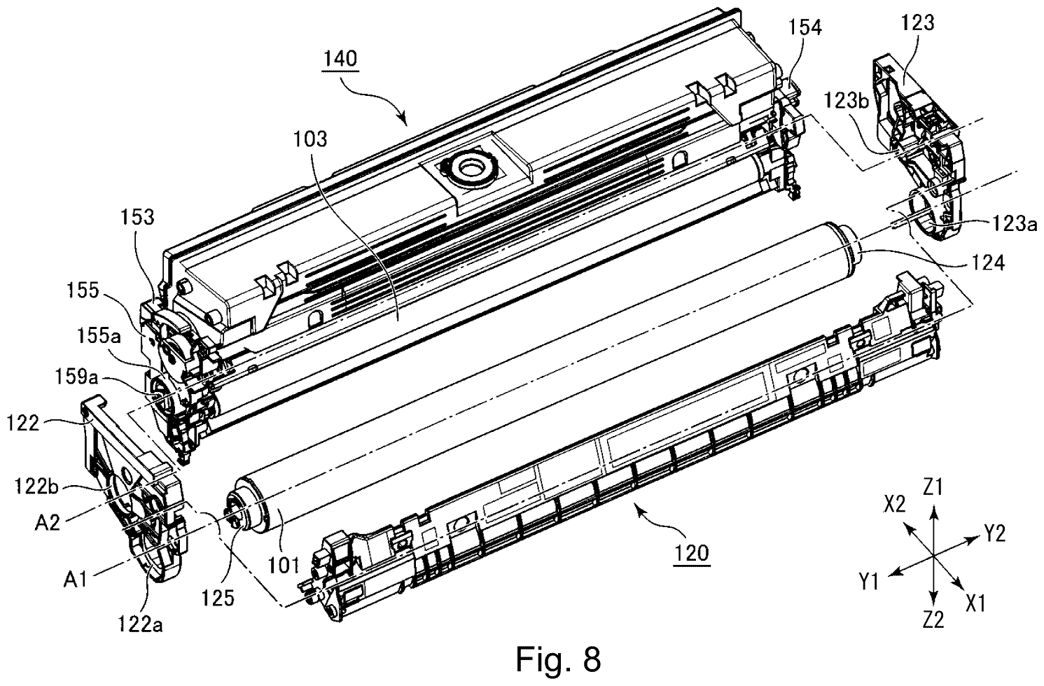

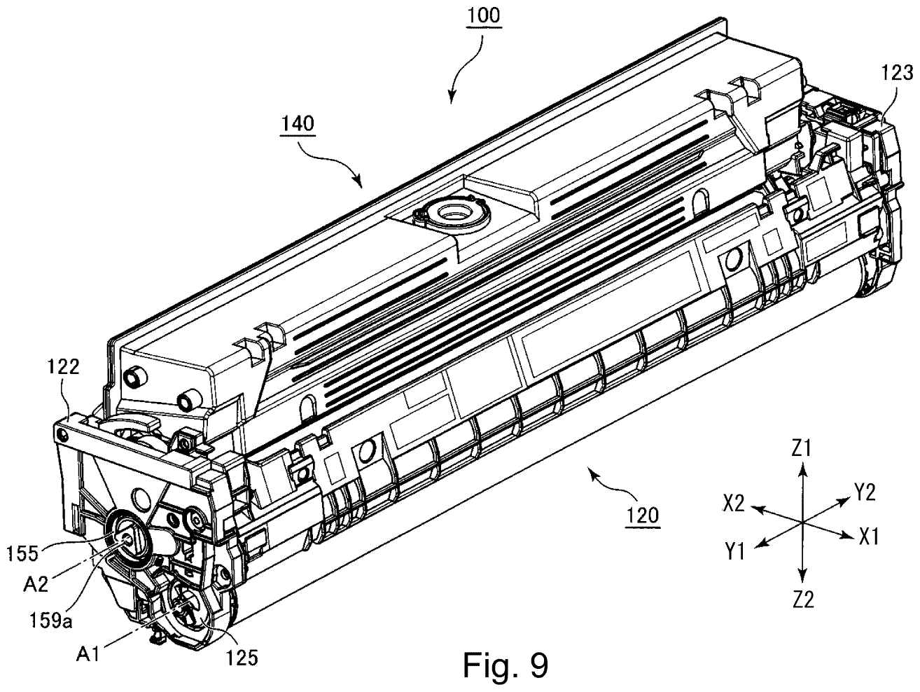

FIG. 5 is a sectional view of the process cartridge 100, showing a state in which a cross section (XZ plane) of the process cartridge 100 substantially perpendicular to the Y direction is viewed from the non-driving side. FIG. 6 is an exploded perspective view of a drum unit 120 described later constituting the process cartridge 100 (FIG. 6 shows a state as viewed from somewhat above along the X1 direction so that the left side is the non-driving side and the right side is the driving side in FIG. 6). FIG. 7 is an exploded perspective view of the developing unit 140 constituting the process cartridge 100 (FIG. 7 shows a state as viewed from somewhat below along the X2 direction so that the left side is the driving side and the right side is the non-driving side in FIG. 7). FIG. 8 is an assembling the process cartridge 100 (FIG. 8 shows a state as viewed from somewhat above along the X2 direction so that the left side is the driving side and the right side is the non-driving side in FIG. 8). FIG. 9 is a perspective view of the process cartridge 100 (FIG. 9 shows a state as viewed from somewhat above along the X2 direction so that the left side is the driving side and the right side is the non-driving side in FIG. 9).

In this embodiment, the process cartridge 100 includes the drum unit 120 provided with the photosensitive drum 101, and as a process means actable thereon, the charging roller 102 which is a charging means. Here, the drum unit 120 may include, as the process means, not only the charging means but also a cleaning means for cleaning a surface of the photosensitive drum 101.

Further, the process cartridge 100 includes, as the process means actable on the photosensitive drum 101, the developing unit (developing device) 140 which is a developing means for developing the electrostatic latent image on the photosensitive drum 101. The drum unit 120 and the developing unit 140 are connected to each other. The process cartridges 100Y, 100M, 100C, and 100K for the colors of yellow, magenta, cyan, and black accommodate toner of the colors of yellow, magenta, cyan, and black, respectively. In the apparatus main assembly 2, above the four process cartridges 100Y, 100M, 100C, and 100K, the laser scanner unit 11 is disposed. This laser scanner unit 11 outputs the laser light 12. Then, the laser light 12 passes through an exposure window 128 of the process cartridge 100, so that the surface of the photosensitive drum 101 is subjected to scanning exposure to the laser light 12. A specific structure of the process cartridge 100 will be described later.

Incidentally, as regards the process cartridge 100, the drum unit 120, the developing unit 140, or elements of these members, a direction substantially parallel to a rotational axis A1 direction (see FIG. 8) of the photosensitive drum 101 is also referred to as a “longitudinal direction”. The process cartridge 100 is disposed so that a rotational axis A1 of the photosensitive drum 101 is disposed so as to become substantially parallel to the Y direction and is used for image formation. Accordingly, the above-described longitudinal direction is a direction substantially parallel to the Y direction.

### <Structure of Drum Unit>

As shown in FIG. 6 and FIG. 8, the drum unit 120 is constituted by including the photosensitive drum 101, the charging roller 102, a drum frame 121, and the like. The charging roller 102 is rotatably supported by a driving-side charge bearing 126a and a non-driving-side charge bearing 127a in a opposite end portions thereof with respect to the longitudinal direction. The charging roller 102 is pressed toward the photosensitive drum 101 (arrow F direction in FIG. 5) by urging the driving-side charge bearing 126a and the non-driving-side charge bearing 127a by pressing springs 126b and 127b, respectively, which are urging members as urging means. The driving-side charge bearing 126a and the pressing spring 126b constitute a driving-side charging roller bearing unit 126. Further, the non-driving-side charge bearing 127a and the pressing spring 127b constitute a non-driving-side charging roller bearing unit 127. Further, to opposite end portions of the charging roller 102 with respect to the longitudinal direction, for example, until use of a new process cartridge 100 is started, separating members 129 and 130 for separating the charging roller 102 from the photosensitive drum 101 are mounted, respectively.

The photosensitive drum 101 is rotatably supported by a driving-side cartridge cover member 122 and a non-driving-side cartridge cover member 123 in opposite end portions thereof with respect to the longitudinal direction. Each of the driving-side cartridge cover member 122 and the non-driving-side cartridge cover member 123 is fixed to the drum frame 121 by an arbitrary fixing means such as bonding, welding, or fastening.

As shown in FIG. 8, in a driving-side end portion of the photosensitive drum 101 with respect to the longitudinal direction, a drum coupling member 125 as a drive input portion for transmitting a driving force to the photosensitive drum 101 is provided. The drum coupling member 125 engages with a main assembly-side drum driving coupling 30 (FIGS. 3 and 4) as a drive output portion provided in the apparatus main assembly 2. Further, a driving force from a driving motor (not shown) provided in the apparatus main assembly 2 is transmitted to the photosensitive drum 101 through the main assembly-side drum driving coupling 30 and the drum coupling member 125, so that the photosensitive drum 101 is rotated. Further, a drum flange 124 is provided in a non-driving-side end portion of the photosensitive drum 101 with respect to the longitudinal direction. The photosensitive drum 101 is rotationally driven in an arrow R1 direction (clockwise direction) in FIG. 5. The charging roller 102 contacts the photosensitive drum 101 and is rotated in an arrow R6 direction (counterclockwise direction) in FIG. 5 with the rotation of the photosensitive drum 101. Each of the driving-side charge bearing 126a and the non-driving-side charge bearing 127a is supported by the drum frame 121 so that the charging roller 102 is capable of being rotated with the rotation of the photosensitive drum 101 in contact with the surface of the photosensitive drum 101. Each of the driving-side charge bearing 126a and the non-driving-side charge bearing 127a is supported by the drum frame 121 so as to be movable in directions toward and away from the photosensitive drum 101. Further, the photosensitive drum 101 is supported by the drum frame 121 by that the drum coupling member 125 and the drum flange 124 are rotatably supported by the driving-side cartridge cover member 122 and the non-driving-side cartridge cover member 123, respectively.

### <Structure of Developing Unit>

As shown in FIGS. 5 and 7, the developing unit 140 is constituted by including the developing roller 103, a supplying roller 104, a sealing sheet 105, a developing blade 156, a conveying member 161, a remaining amount detecting member (electroconductive sheet) 170, a development frame 150, and the like. The development frame 150 constitutes a developer container for accommodating the developer (toner). The development frame 150 is constituted by a first development frame 151 and a second development frame 152 which are frames (resin frames) formed of a resin. In this embodiment, the first development frame 151 and the second development frame 152 are bonded together by ultrasonic welding. However, the first development frame 151 and the second development frame 152 can be fixed to each other by an arbitrary fixing means such as bonding, welding, or fastening. The development frame 150 forms a developing chamber 106 provided with the developing roller 103 and the like, and a developer accommodating chamber (“accommodating chamber”) 107 for accommodating the toner supplied to the developing roller 103. The developing chamber 106 and the accommodating chamber 107 are partitioned by a partition wall 167 constituted by a part of the development frame 150 (first development frame 151).

First, in the developing chamber 106, the developing roller 103 as a developer carrying member (developing member) for conveying the toner toward a developing portion (developing nip) N3 which is an opposing portion (contact portion) with the photosensitive drum 101 while carrying the toner. Further, in the developing chamber 106, the supplying roller 104 as a supplying member for supplying the toner to the developing roller 103 is provided. In addition, in the developing chamber 106, the developing blade 156 as a regulating member is provided. In addition, in the developing chamber 106, the sealing sheet 105 as the sealing member is provided.

The developing roller 103 is an electroconductive rubber roller prepared by forming an electroconductive rubber layer as an elastic layer on an outer periphery of an electroconductive core metal. In this embodiment, the developing roller 103 is rotationally driven in an arrow R3 direction in FIG. 5 about a rotational axis B1 substantially parallel to the longitudinal direction of the developing unit 140. That is, the developing roller 103 is rotationally driven in a direction in which a surface movement direction of the photosensitive drum 101 and a surface movement direction of the developing roller 103 become the same (forward) direction in the developing portion N3.

The supplying roller 104 is an elastic sponge roller prepared by forming a foamed elastic (member) layer as an elastic layer on an outer periphery of an electroconductive core metal. That is, the supplying roller 104 includes a foamed member (porous member) on a surface (outer peripheral surface) thereof. The supplying roller 104 contacts the developing roller 103 with a predetermined penetration amount, so that the foamed elastic layer constituting a surface layer of the supplying roller 104 is compressed and recessed by the elastic layer of the developing roller 103 higher in rigidity than the foamed elastic layer. A contact portion between the developing roller 103 and the supplying roller 104, i.e., a region (region-to-be-compressed) in which the supplying roller 104 is compressed by the developing roller 103 is also referred to as a supplying portion (supplying nip) N4. In this embodiment, the supplying roller 104 is rotationally driven in an arrow R4 direction (counterclockwise direction) in FIG. 5 about a rotational axis B2 substantially parallel to the longitudinal direction of the developing unit 140. That is, the supplying roller 104 is rotationally driven in a direction in which the surface movement direction of the developing roller 103 and a surface movement direction of the supplying roller 104 becomes opposite directions to each other in the supplying portion N4. In the supplying portion N4, the toner is supplied to the developing roller 103 by the supplying roller 104.

The developing blade 156 is provided in contact with the surface of the developing roller 103 on a side downstream of the supplying portion N4 and upstream of the developing portion N3 with respect to the rotational direction of the developing roller 103.

In this embodiment, the developing blade 156 includes a regulating portion 156b constituted by an electrically deformable sheet-like member formed of metal in a thickness of about 0.1 mm, and a supporting member 156a constituted by a plate-like member (metal plate) formed of metal in an approximate L-shape in cross section (XZ plane) substantially perpendicular to the longitudinal direction. The regulating portion 156b is fixed to the supporting portion 156a in one end portion (fixing end portion) with respect to a widthwise direction substantially perpendicular to the longitudinal direction thereof. In this embodiment, the regulating portion 156b is fixed to the supporting member 156a by welding. However, the regulating portion 156b can be fixed to the supporting member 156a by an arbitrary fixing means such as bonding, welding, or fastening. The developing blade 156 is disposed so that the other end portion (free end portion) with respect to the widthwise direction of the regulating portion 156b is directed toward the upstream side with respect to a rotational direction of the developing roller 103. Further, the regulating portion 156b contacts the surface of the developing roller 103 at a side surface thereof in the neighborhood of a free end of the free end portion thereof with respect to the widthwise direction. The developing blade 156 regulates a layer thickness (coating amount) of the toner supplied to the developing roller 103 by the supplying roller 104. The developing blade 156 may have a function of imparting the electric charge to the toner. The developing blade 156 is held by the development frame 150 as described later.

Further, the sealing sheet 105 is provided so as to contact the surface of the developing roller 103 on a side downstream of the developing portion N3 and upstream of the supplying portion N4 with respect to the developing roller 103. The sealing sheet 105 is constituted by a flexible sheet-like member formed of a resin. The sealing sheet 105 is fixed to the development frame 150 as described later at one end portion (fixing end portion) thereof with respect to a widthwise direction substantially perpendicular to a longitudinal direction thereof. The sealing sheet 105 is disposed toward a downstream side with respect to the rotational direction of the developing roller 103 at the other end portion (free end portion) with respect to the widthwise direction thereof. Further, the sealing sheet 105 contacts the surface of the developing roller 103 at a side surface thereof in the neighborhood of a free end of the free end portion thereof with respect to the widthwise direction. The sealing sheet 105 prevents leaks of the toner from the developing chamber 106 to an outside.

On the other hand, in this embodiment, the accommodating chamber 107 is disposed above the developing chamber 106, i.e., above the supplying roller 104, and accommodates therein the toner to be supplied to the developing chamber 106. The partition wall 167 for partitioning between the developing chamber 106 and the accommodating chamber 107 is provided with an opening 168 which is an opening for permitting passing of the toner from the accommodating chamber 107 toward the developing chamber 106 by establishing communication between the developing chamber 106 and the accommodating chamber 107. In the accommodating chamber 107, the conveying member (developer conveying member) 161 for conveying the toner accommodated in the accommodating chamber 107 is disposed. The conveying member 161 also has a function as a stirring member (developer stirring member) for stirring the toner accommodated in the accommodating chamber 107. Further, in the accommodating chamber 107, the remaining amount detecting member (electroconductive sheet) 170 for detecting a remaining amount of the developer in the developing unit 140 (accommodating chamber 107) is provided.

The accommodating chamber 107 roughly includes a bottom (surface) 191, a front-side inner wall surface 192, a top surface 193, and a rear-side inner wall surface 194. The bottom 191 is constituted by an inner wall surface of the partition wall 167. The front-side inner wall surface 192 is constituted by an inner wall surface extending along an up-down (vertical) direction so as to connect the bottom 191 and the top surface 193 on a front side of the accommodating chamber 107. The top surface 193 is constituted by an inner wall surface extending along a horizontal direction so as to connect the front-side inner wall surface 192 and the rear-side inner wall surface 194. The rear-side inner wall surface 194 is constituted by an inner wall surface extending along the up-down (vertical) direction so as to connect the top surface 193 and the bottom 191 on a rear side of the accommodating chamber 107. In this embodiment, the bottom 191 (partition wall 167), the top surface 193, and the rear-side inner wall surface 194 of the accommodating chamber 107 are formed by the first development frame 151. Further, in this embodiment, the front-side inner wall surface 192 of the accommodating chamber 107 and a bottom 195 of the developing chamber 106 are formed by the second development frame 152. However, the development frame 150 is not limited to the constitution of this embodiment, but for example, the development frame 150 may be constituted by connecting three or more frames to each other, or portions constituted by respective frames in the development frame 150 may be different from those in this embodiment.

The conveying member 161 includes a shaft portion 161a provided substantially parallel to the longitudinal direction of the developing unit 140 and two conveying sheets (stirring sheets) 161b and 161c which are flexible sheet-like members each constituting a conveying portion for conveying the toner. The shaft portion 161a is provided over a substantially whole region between the inner wall surfaces on opposite sides of the accommodating chamber 107 with respect to the longitudinal direction. Each of the conveying sheets 161b and 161c is a sheet-like member extending over a substantially whole region of the shaft portion 161a with respect to the longitudinal direction. In addition, each of the conveying sheets 161b and 161c is fixed to the shaft portion 161a at one end portion (fixing end portion) thereof with respect to a widthwise direction (rotation radius direction) substantially perpendicular to the longitudinal direction. Each of the conveying sheets 161b and 161c is fixed to the shaft portion 161a by an arbitrary fixing means such as bonding, welding, or fastening. The other end portion of each of the conveying sheets 161b and 161c is a free end portion. The two conveying sheets 161b and 161c are fixed to an outer surface of the shaft portion 161a on sides opposite from each other so as to extend in opposite directions each toward an outside of the shaft portion 161a with respect to the rotation radius direction. The conveying member 161 is rotationally driven in an arrow R5 direction (counterclockwise direction) in FIG. 5 about a rotational axis O substantially parallel to the longitudinal direction of the developing unit 140. The shaft portion 161a is rotated in the arrow R5 direction in FIG. 5, so that the conveying sheets 161b and 161c are rotated in the same direction with rotation of the shaft portion 161a. By this, the conveying member 161 conveys (stirs) the toner by the conveying sheets 161b and 161c. As the conveying sheets 161b and 161c, it is possible to use a polyester film, a polyphenylene sulfide film, a polycarbonate film, or the like each having an appropriate thickness (for example, 300 μm).

The remaining amount detecting member (electroconductive sheet) 170 is provided on the front-side inner wall surface 192 in the accommodating chamber 107. Incidentally, details of a remaining amount detecting constitution for detecting a remaining amount of the developer in the developing unit 140 (accommodating chamber 107) will be described later.

As shown in FIG. 7, the developing roller 103 and the supplying roller 104 are rotatably supported by a driving-side development bearing 153 and a non-driving-side development bearing 154 in opposite end portions with respect to each of longitudinal directions thereof. Each of the driving-side development bearing 153 and the non-driving-side development bearing 154 is fixed to the development frame 150 (first development frame 151, second development frame 152) by an arbitrary fixing means such as bonding, welding, or fastening. Further, in this embodiment, the developing blade 156 is fixed to the development frame 150 by that the supporting portion 156 is fixed on the development frame 150 (first development frame 151) by fixing screws 156c in two positions on one end portion side and the other end portion side with respect to the longitudinal direction. However, the developing blade 156 can be fixed to the development frame 150 by an arbitrary fixing means such as bonding, welding, or fastening. Further, in this embodiment, the sealing sheet 105 is mounted to the development frame 150 by a double-side tape. However, the sealing sheet 105 can be fixed to the development frame 150 by an arbitrary fixing means such as bonding, welding, or fastening. Further, the conveying member 161 (shaft portion 161a) is rotatably supported by the driving-side development bearing 153 and the non-driving-side development bearing 154 is opposite end portions with respect to the longitudinal direction. Incidentally, details of the sealing sheet 105 and a mounting method thereof will be described later.

As shown in FIG. 7, in a driving-side end portion of the development unit 140 with respect to the longitudinal direction, a development drive input gear 159 as a drive transmitting member for transmitting a driving force of the development unit 140 is provided. The development drive input gear 159 is provided with a development drive input coupling portion 159a as a drive input portion. The development drive input coupling portion 159a engages with a main assembly-side development drive coupling portion 40 (FIGS. 3 and 4) as a drive output portion provided in the apparatus main assembly 2. Further, a driving force from the driving motor (not shown) provided in the apparatus main assembly 2 is inputted to the development unit 140 through the development drive input gear 159.

The driving force inputted to the development unit 140 is transmitted from the development drive input gear 159 to a developing roller gear 157 as a drive transmitting member, so that the developing roller 103 is rotated. Further, the driving force inputted to the developing unit 140 is transmitted from the development drive input gear 159 to a supplying roller gear 158 as a drive transmitting member, so that the supplying roller 104 is rotated.

Further, the driving force inputted to the developing unit 140 is transmitted from the development drive input gear 159 to a conveying gear 160 as a drive transmitting member, so that the conveying member 161 is rotated. The developing roller gear 157, the supplying roller gear 158, and the conveying gear 160 are rotatably supported by the driving-side development bearing 153. Further, in a driving-side end portion of the developing unit 140 with respect to the longitudinal direction, a development cover member 155 for supporting the development drive input gear 159 and for covering the development drive input gear 159, the developing roller gear 157, the supplying roller gear 158, and the conveying gear 160, and the like is provided.

### <Assembling of Drum Unit and Developing Unit>

Next, assembling of the drum unit 120 and the developing unit 140 will be described.

As shown in FIG. 8, the drum unit 120 and the developing unit 140 are connected to each other by the driving-side cartridge cover member 122 and the non-driving-side cartridge cover member 123 provided in opposite end portions of the process cartridge 100 with respect to the longitudinal direction. The driving-side cartridge cover member 122 provided in the driving-side end portion of the process cartridge 100 with respect to the longitudinal direction is provided with a developing unit supporting hole 122b for swingably (movably) supporting the developing unit 140. Similarly, the non-driving-side cartridge cover member 123 provided in the non-driving-side end portion of the process cartridge 100 with respect to the longitudinal direction is provided with a developing unit supporting hole 123b for swingably supporting the developing unit 140. Further, the driving-side cartridge cover member 122 and the non-driving-side cartridge cover member 123 are provided with drum supporting holes 122a and 123a, respectively, for rotatably supporting the photosensitive drum 101.

In the driving-side end portion of the process cartridge 100 with respect to the longitudinal direction, in the developing unit supporting hole 122b of the driving-side cartridge cover member 122, an outer diameter portion of a cylindrical portion 155a of the development cover member 155 is engaged. Further, in the non-driving-side end portion of the process cartridge 100 with respect to the longitudinal direction, in the developing unit supporting hole 123b of the non-driving-side cartridge cover member 123, an outer diameter portion of a cylindrical portion (not shown) of the non-driving-side development bearing 154 is engaged. Further, opposite end portions of the photosensitive drum 101 with respect to the longitudinal direction are engaged in the drum supporting hole 122a of the driving-side cartridge cover member 122 and the drum supporting hole 123a of the non-driving-side cartridge cover member 123. Then, the driving-side cartridge cover member 122 and the non-driving-side cartridge cover member 123 are fixed to the drum unit 120 (drum frame 121) by an arbitrary fixing means such as screws, an adhesive, or the like. By this, the developing unit 140 is rotatably (swingably) supported relative to the drum unit 120 (photosensitive drum 101) by the driving-side cartridge cover member 122 and the non-driving-side cartridge cover member 123. For that reason, during the image formation, the developing roller 103 can be positioned in a position (contact position in this embodiment) where the developing roller 103 acts on the photosensitive drum 101.

As shown in FIG. 9, in the above-described manner, the drum unit 120 and the developing unit 140 are assembled, so that the process cartridge 100 is integrally formed.

Incidentally, an axis connecting a center of the developing unit supporting hole 122b of the driving-side cartridge cover member 122 and a center of the developing unit supporting hole 123b of the non-driving-side cartridge cover member 123 is also referred to as a swing axis A2. Here, the cylindrical portion 155a of the development cover member 155 is coaxial with the development drive input coupling 159a. That is, the developing unit 140 is constituted so that the driving force is transmitted on the above-described swing axis A2. With the above-described swing axis A2 as a center, the developing unit 140 is rotatably supported relative to the drum unit 120.

### <Remaining Amount Detecting Constitution>

Next, a remaining amount detecting constitution for detecting a remaining amount of the developer in the developing unit 140 (accommodating chamber 107) in this embodiment.

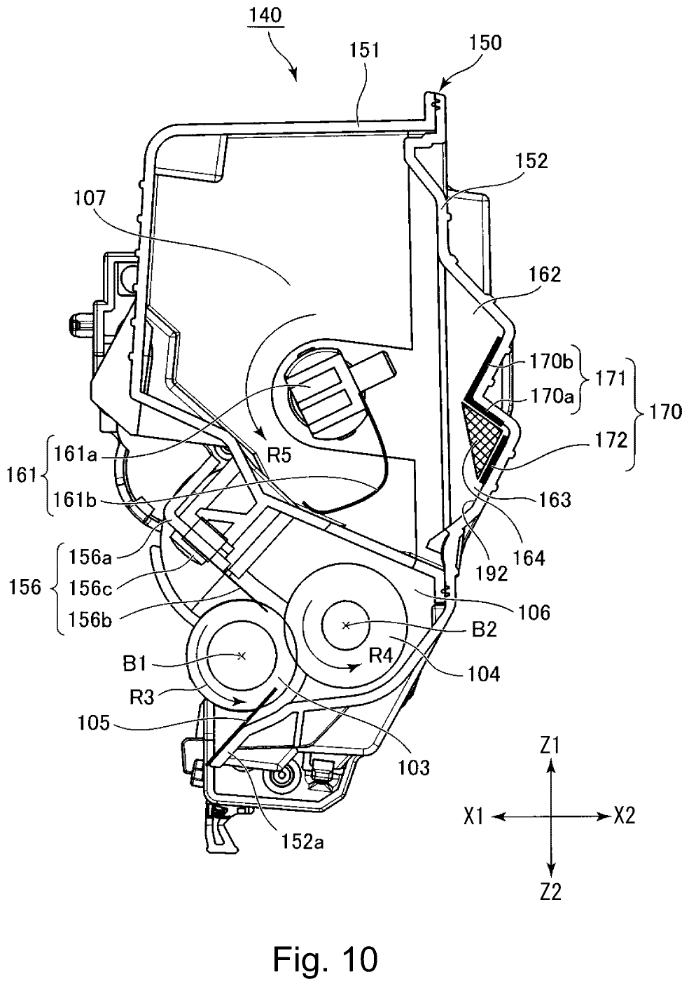

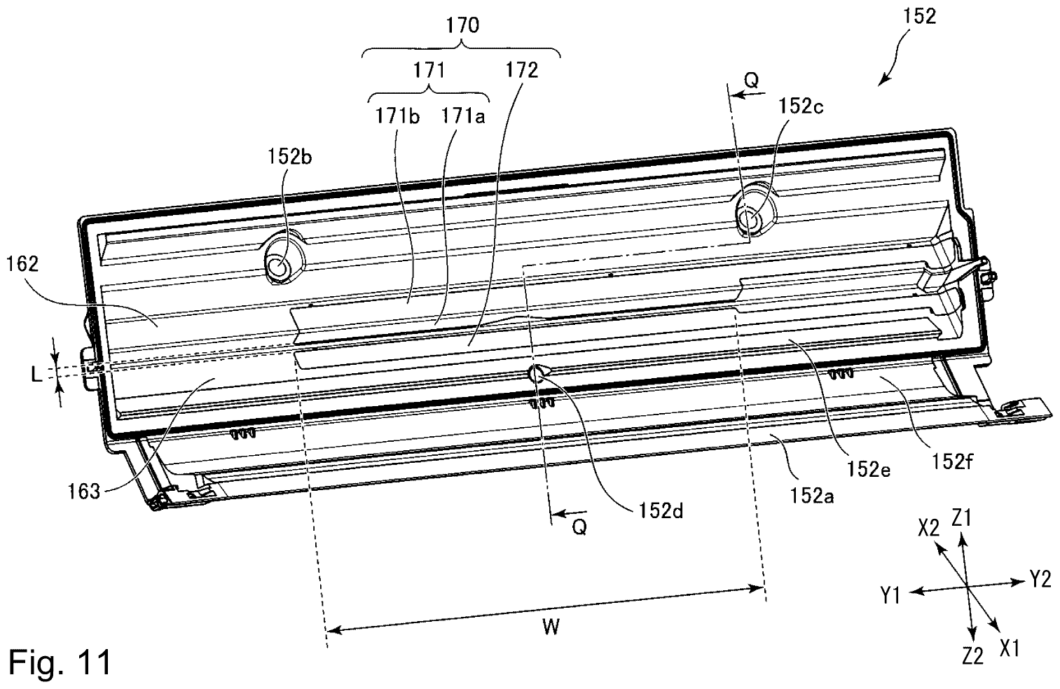

FIG. 10 is a schematic sectional view of the developing unit 140 at a substantially center position with respect to the longitudinal direction (showing a state in which the cross section (XZ plane) substantially perpendicular to the Y direction is viewed from the non-driving side). FIG. 11 is a perspective view of the second development frame 152 (showing a state in which the development frame 152 is viewed from somewhat at above along the X2 direction so that the left side in FIG. 10 is the driving side and the right side is the non-driving side). FIG. 11 is a sectional view taken along Q-Q line in FIG. 11 (showing a state in which the second development frame 152 is viewed from the non-driving side along the Y direction). In FIGS. 10 to 12, although the developing unit 140 is the developing unit 140 according to this embodiment similarly as shown in FIG. 5 and the like, but for simplicity, the developing unit 140 (or elements thereof) having a constitution in which a conveying member 161 is provided with only a single conveying sheet 161b is shown. The same applies to FIG. 14 described later.

On the front-side inner wall surface 192 of the second development frame 152 (accommodating chamber 107), a recessed portion 163 extending (substantially parallel to) along the longitudinal direction of the second development frame 152 is formed. The recessed portion 163 includes an upper surface (first surface) 163a of the inner wall surface of the accommodating chamber 107 and a lower surface (second surface) 163b of the inner wall surface of the accommodating chamber 107 which is positioned on a side downstream of the supply opening 168 and upstream of the upper surface 163a with respect to the longitudinal direction of the conveying member 161. In the cross section (XZ plane) substantially perpendicular to the longitudinal direction of the second development frame 152, the upper surface 163a of a flat surface inclined so as to be positioned on an outer side of the accommodating chamber 107 toward a lower side thereof, and the lower surface 163b is a flat surface inclined so as to be positioned on the outer side of the accommodating chamber 107 toward an upper side thereof. That is, in the cross section (XZ plane) substantially perpendicular to the longitudinal direction of the second development frame 152, the upper surface 163a is constituted by a plane inclined so that a distance thereof from the rotational axis O of the conveying member 161 becomes shorter toward a downstream side of the rotational direction of the conveying member 161. Further, in the cross section (X2 plane) substantially perpendicular to the longitudinal direction of the second development frame 152, the lower surface 163b is constituted by a plane inclined so that a distance thereof from the rotational axis O of the conveying member 161 becomes longer toward the downstream side of the rotational direction of the conveying member 161. The upper surface (second surface) 163a and the lower surface (third surface) 163b are surfaces arranged in the Z direction and cross each other. That is, the lower surface 163b is a surface provided adjacently to the upper surface 163a and crossing the upper surface 163a. The upper surface 163a and the lower surface 163b are continuous at a bottom 163c of the recessed portion 163. An electroconductive sheet 170 which is an electroconductive resin-like member (resin sheet) constituting a remaining amount detecting member is provided on the upper surface 163a and the lower surface 163b which are two surfaces forming the recessed portion 163.

In this embodiment, inside the second development frame 152, as the electroconductive sheet 170, a first electroconductive sheet 171 and a second electroconductive sheet 172 are provided. The first electroconductive sheet 171 is disposed on the upper surface 163a of the recessed portion 163, and the second electroconductive sheet 172 is disposed on the lower surface 163b of the recessed portion 163. The first electroconductive sheet 171 and the second electroconductive sheet 172 are disposed with a recessed portion interval L therebetween without contacting each other. On the front-side inner wall surface 192 of the second development frame 152 (accommodating chamber 107), another recessed portion 162 extending along (substantially parallel to) the longitudinal direction of the second development frame 152 is formed above and adjacently to the recessed portion 163. This another recessed portion 162 includes an apex portion 162a continuous to the upper surface 163a of the recessed portion 163 and an inclined surface 162b continuous to the apex portion 162a. In the cross section (XZ plane) substantially perpendicular to the longitudinal direction of the second development frame 152, the inclined surface 162b is a flat surface inclined so as to be positioned on the outer side of the accommodating chamber toward the upper side thereof. That is, in the cross section (XZ plane) substantially perpendicular to the longitudinal direction of the second development frame 152, the inclined surface 162b is constituted by a flat surface inclined so that a distance from the rotational axis O of the conveying member 161 becomes long toward the downstream side of the rotational direction of the conveying member 161. The upper surface 163a (second surface) of the recessed portion 163 and the inclined surface (first surface) 162b of the another recessed portion 162 are surfaces arranged in the Z direction and cross each other. The first electroconductive sheet 171 is disposed so as to be continuous over two surfaces consisting of the upper surface 163a of the recessed portion 163 and the inclined surface 162b of the above-described another recessed portion 162.

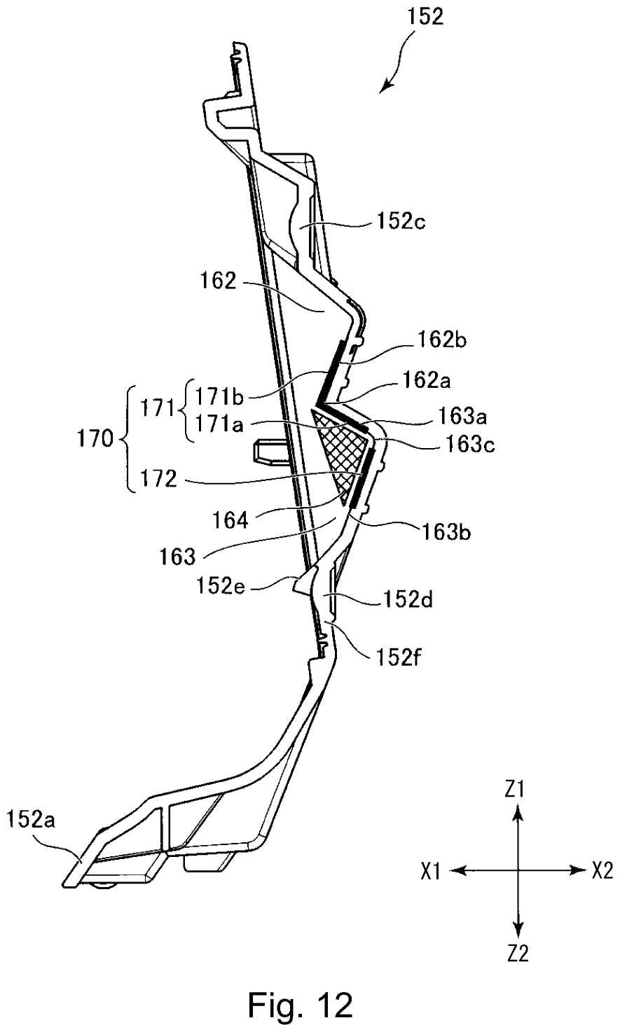

The first electroconductive sheet 171 is provided so that a second portion 172b which is a portion thereof disposed on the inclined surface 162b of the another recessed portion 162 is continuous to the non-driving-side end portion of the second development frame 152 with respect to the longitudinal direction. Further, the second electroconductive sheet 172 is provided so as to be continuous on the lower surface 163b of the recessed portion 163 to the non-driving-side end portion of the second development frame 152 with respect to the longitudinal direction. A first portion 171a which is a portion of the first electroconductive sheet 171 disposed on the upper surface 163a of the recessed portion 163 and a portion of the second electroconductive sheet 172 disposed opposed to this portion (of the first electroconductive sheet 17) on the lower surface 163b of the recessed portion 163 are arranged adjacently to each other with the predetermined interval L. That is, a closest portion between the first electroconductive sheet 171 and the second electroconductive sheet 172 is limited to a predetermined range (detection range) W extending symmetrically from a center of the second development frame 152 toward each of opposite end portion sides with respect to the longitudinal direction. A space (hatched portion in FIGS. 10 and 12) sandwiched between the first portion 171a of the first electroconductive sheet 171 and the second electroconductive sheet 172 in the detection range W is a remaining amount detecting portion 164.

Incidentally, a shape of the recessed portion 163 in which the remaining amount detecting portion 164 is provided is not limited to the shape in this embodiment. For example, an appropriate shape such as a recessed portion constituted by a curved surface can be used.

Here, in this embodiment, as described above, the first and second electroconductive sheets 171 and 172 are formed with an electroconductive resin sheet. In this embodiment, a thickness of the first and second electroconductive sheets 171 and 172 is 0.1 mm. In this embodiment, as the first and second electroconductive sheets 171 and 172, a resin sheet of 1.15 kΩ/sq or less in surface resistivity was used. Further, in this embodiment, as a material of the first and second electroconductive sheets 171 and 172, a resin of an ethylene vinyl acetate copolymer (EVA) type in which carbon black was dispersed was used. Further, in this embodiment, as specifically described later, the first and second electroconductive sheets 171 and 172 are provided by being integrally molded with the second development frame 152 by insert molding. Incidentally, in this embodiment, from viewpoints of the influence of deformation of the frame, a transfer property to a frame shape, electroconductivity, and the like, as the first and second electroconductive sheets 171 and 172, the 0.1 mm-thick resin sheet was used, but the thickness of the resin sheet can be appropriately selected. Further, in this embodiment, as the material of the first and second electroconductive sheets 171 and 172, the resin of EVA type was used, but resins of polystyrene (PS) type, acrylonitrile butadiene styrene (ABS) type, polyphenylene oxide (PRO) type, and the like may be used.

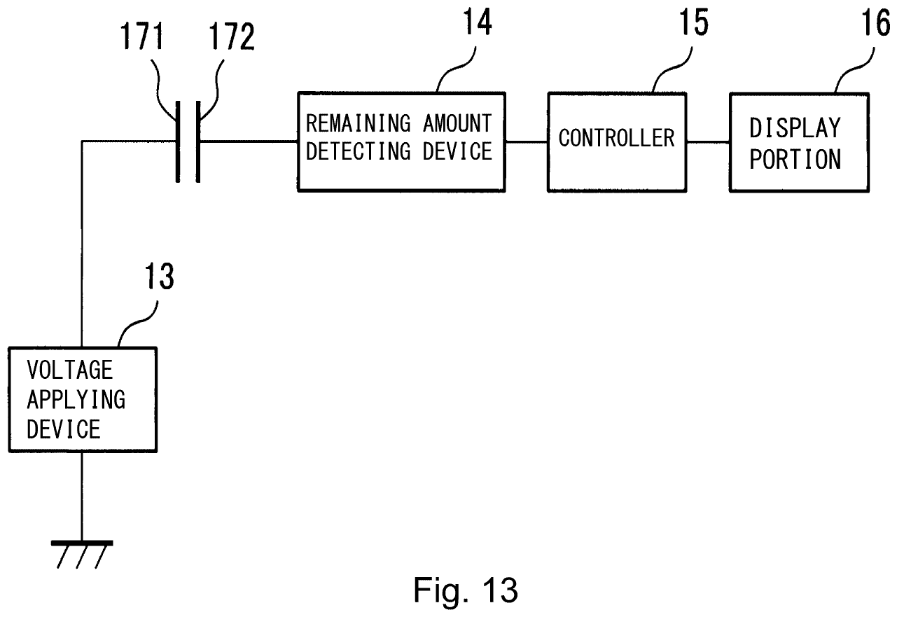

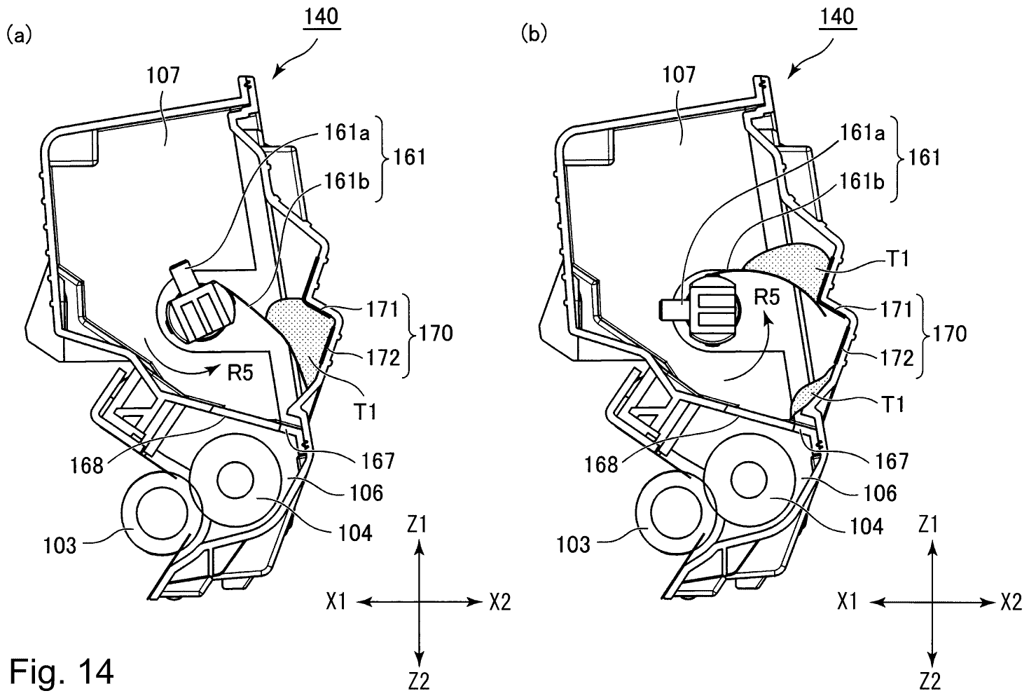

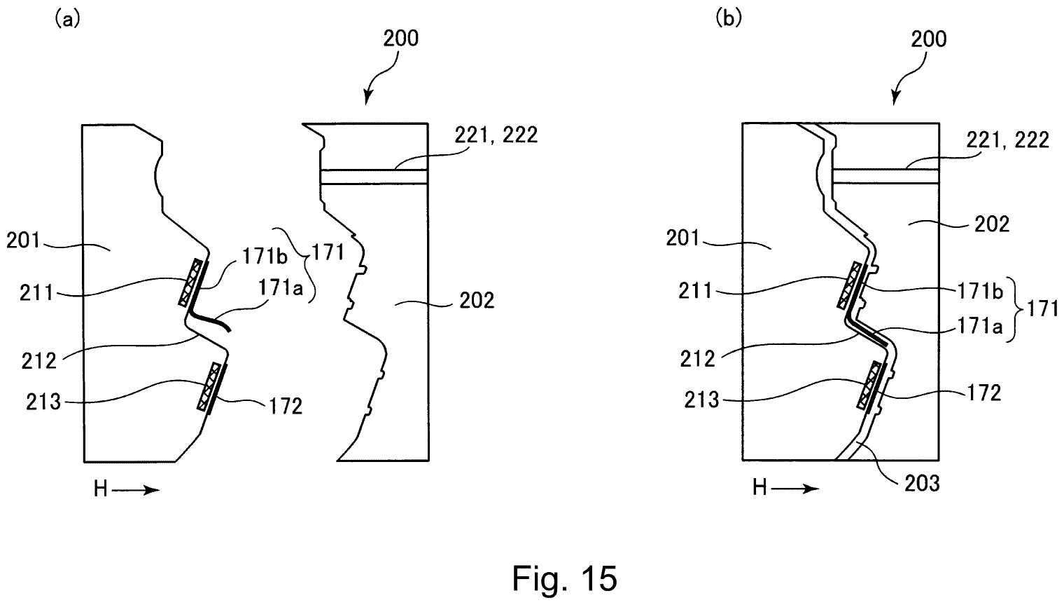

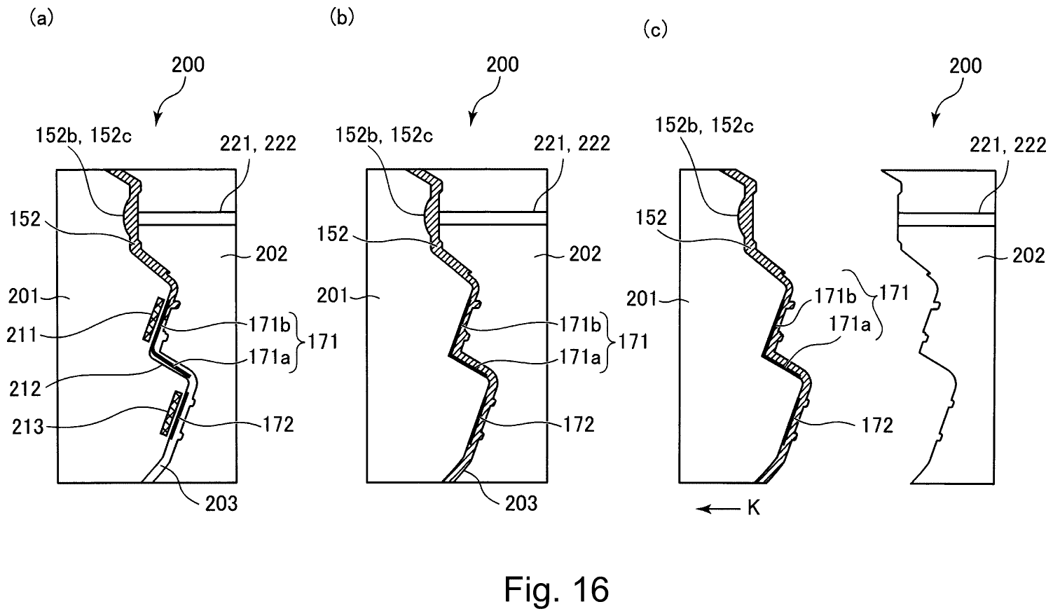

FIG. 13 is a schematic view showing a schematic circuit constitution of a remaining amount detecting constitution in this embodiment. A method for measuring electrostatic capacity of the remaining amount detecting portion 164 by the first and second electroconductive sheets 171 and 172 will be described. In the apparatus main assembly 2, a voltage applying device (power source) 13 capable of applying an AC voltage (alternating voltage) as a remaining amount detecting bias (remaining amount detecting voltage) to the first electroconductive sheet 171, and a remaining amount detecting device (detecting circuit) 14 electrically connected to the second electroconductive sheet 172 are provided. Electric conduction between the first and second electroconductive sheet 171 and 172 disposed inside the second development frame 152, and the voltage applying device 13 and the remaining amount detecting device 14 disposed outside the second development frame 152 may only be required to be established by an arbitrary method.

For example, a part of the second development frame 152 is constituted by the electroconductive resin or the electroconductive member is incorporated into a part of the second development frame 152, so that the members inside and outside the second development frame 152 can be constituted so as to be electrically connected to each other. The first and second electroconductive sheets 171 and 172 perform a function as pole plates, and form a capacitor inside the developing unit 140.

When an AC voltage is applied to the first electroconductive sheet 171, a current corresponding to electrostatic capacity is induced in the remaining amount detecting portion 164 which is a space between the first electroconductive sheet 171 and the second electroconductive sheet 172. An angle formed between the first electroconductive sheet 171 and the second electroconductive sheet 172 in a portion forming the remaining amount detecting portion 164 may preferably be set to 95° or more and 110° or less, in which the electrostatic capacity can be stably measured. This electrostatic capacity changes depending on an amount of the developer occupied in the remaining amount detecting portion 164. A change in electrostatic capacity is inputted as a current value to the remaining amount detecting device 14. Then, a controller (control circuit) 15 provided in the apparatus main assembly 2 is capable of sequentially calculating the remaining amount of the developer in the developing unit 140 (accommodating chamber 107) on the basis of the current value inputted to the remaining amount detecting device 14. Further, the controller 15 is capable of carrying out control so as to notify information on the remaining amount of the developer in the developing unit 140 to a display portion 16 provided to the apparatus main assembly 2 or a display portion of an external device such as a personal computer or the like connected to the image forming apparatus 1. Incidentally, an electrostatic capacity detecting method is not limited to the above-described method. For example, a constitution in which the first electroconductive sheet 171 is electrically connected to the remaining amount detecting device 14 and the second electroconductive sheet 172 is electrically connected to the voltage applying device and in which the electrostatic capacity is detected by applying an AC voltage to the second electroconductive sheet 172 may be employed.

With reference to FIG. 14, a relationship between an operation of the conveying member 161 and a detecting operation of the amount of the developer by the remaining amount detecting portion 164 will be further described. As described above, the recessed space sandwiched between the first electroconductive sheet 171 and the second electroconductive sheet 172 in the detection range W is the remaining amount detecting portion 164. Further, the amount of the developer conveyed into the remaining amount detecting portion 164 by the conveying member 161 is detected.

Part (a) of FIG. 14 is a schematic sectional view of the developing unit 140 similar to FIG. 10 and shows a state at the moment when a developer (toner)-to-be-conveyed T1 is conveyed to the remaining amount detecting portion 164 by the conveying sheet 161b and is detected by the remaining amount detecting portion 164. In this embodiment, a length of the conveying sheet 161b with respect to the widthwise direction is set so that a free end of a free end portion of the conveying sheet 161b is movable in contact with at least a part of the bottom 191 and the front-side inner wall surface 192 of the accommodating chamber 107. At least the part of the front-side inner wall surface 192 typically includes at least a part of the lower surface 163b of the recessed portion 163. That is, in the cross section (XZ plane) substantially perpendicular to the longitudinal direction of the developing unit 140, the length of the conveying sheet 161b with respect to the widthwise direction is longer than a distance from the rotational axis (rotation center) O of the conveying member 161 to at least the part of the bottom 191 and the front-side inner wall surface 192. For that reason, even in the case where the amount of the developer in the accommodating chamber 107 is relatively small as shown in part (a) of FIG. 14, the conveying sheet 161b raises the developer and conveys the developer to the remaining amount detecting portion 164. Thus, the conveying member 161 is constituted so that an outside free end thereof with respect to the rotation radius direction is moved in contact with at least a part of the partition wall 167. Further, in the case where the developing unit 140 takes an attitude when the developing unit 140 is used for image formation in the image forming apparatus 1, the remaining amount detecting portion 164 is provided on the inner wall surface of the accommodating chamber 107 in a position where a free end of the conveying member 161 is moved upward while contacting the inner wall surface immediately after being separated from the partition wall 167. That is, in the case where the developing unit 140 takes the attitude when the developing unit 140 is used for the image formation in the image forming apparatus 1, at least a part of the remaining amount detecting portion 164 is disposed in a position where the developer raised and conveyed by the conveying member 161 is supplied. Incidentally, in this embodiment, the conveying sheet 161b conveys the developer while being flexed in an opposite direction to the rotational direction of the conveying member 161. At this time, the developer (toner) is a dielectric material, so that the electrostatic capacity between the first and second electroconductive sheets 171 and 172 performing the function of the pole plates of the capacitor increases.

On the other hand, part (b) of FIG. 14 is a schematic sectional view of the developing unit 140 similar to FIG. 10 and shows a state immediately after the conveying sheet 161b passes through the remaining amount detecting portion 164. A part of the developer-to-be-conveyed T1 is raised upward than the remaining amount detecting portion 164 by the conveying sheet 161b, and a part of the developer-to-be-conveyed T1 drops from the remaining amount detecting portion 164 by its own weight, so that a distribution as shown in part (b) of FIG. 15 is obtained. Thus, the developer which is the dielectric material runs out (or decreases) in the remaining amount detecting portion 164, so that the electrostatic capacity between the first and second electroconductive sheets 171 and 172.

Incidentally, as described above, for simplicity, only one conveying sheet 161b is shown in FIG. 15, but in this embodiment, behavior of the developer by each of the two conveying sheets 161b and 161c is substantially the same.

With consumption of the developer by the image formation, the amount of the developer conveyed by the conveying member 161 gradually decreases. For that reason, a “time when the developer exists in the remaining amount detecting portion 164”, i.e., a “time when the electrostatic capacity increases” similarly decreases. In this embodiment, the remaining amount detecting device 14 is constituted so as to be capable of detecting the remaining amount of the developer in the developing unit 140 (accommodating chamber 107) by measuring this decreasing “time when the electrostatic capacity increases”. Thus, the remaining amount detecting device 14 is capable of acquiring a detection result correlating with an amount of the developer accommodated in the development frame (developer container) 150 on the basis of the electrostatic capacity between the first electroconductive sheet 171 and the second electroconductive sheet 172.

### <Sealing Sheet and Sealing Bearing Surface>

With reference to FIGS. 10 to 12, the sealing sheet 105 and a mounting method thereof in this embodiment will be described.

The toner in the accommodating chamber 107 is conveyed (and stirred) by rotation of the conveying member 161 and then is supplied to the developing chamber 106 in which the developing roller 103 and the supplying roller 104 are provided. The toner supplied to the developing chamber 106 is moved from the supplying roller 104 to the developing roller 103, and is moved from the developing roller 103 to the photosensitive drum 101, so that the electrostatic latent image on the photosensitive drum 101 is developed with the toner.

To the surface (outer peripheral surface) of the developing roller 103, the sealing sheet 105 is contacted for the purpose of preventing leakage of the toner to an outside from the developing chamber 106. The sealing sheet 105 is fixed to a sealing bearing surface 152a of the second development frame 152. The sealing bearing surface 152a extends along the longitudinal direction in a lower-side end portion of the second development frame 152 in the cross section substantially perpendicular to the longitudinal direction of the developing unit 140. In this embodiment, the sealing sheet 105 is mounted to the sealing bearing surface 152a by a double-side tape as a sticking means. In this embodiment, the sealing sheet 105 is constituted by a sheet-like member of a 0.06 mm-thick polyphenylene sulfide (PPS). Further, this sealing sheet 105 is stuck to the sealing bearing surface 152a with a 0.135 mm-thick double-side tape. However, the present invention is not limited thereto, but the thickness and the material of the sealing sheet 105 and the mounting method of the sealing sheet 105 can be appropriately selected.

The sealing sheet 105 is contacted to the developing roller 103 along the longitudinal direction and seals a gap between the developing sleeve 103 and the development frame 150 (second development frame 152), so that toner leakage is prevented. However, when there is a portion (gap portion) where a part of the sealing sheet 105 cannot be contacted to the developing roller 103, there is a possibility that the toner leaks out from the (gap) portion. As a reason for causing the gap between the sealing sheet 105 and the developing roller 103, it is possible to cite waving during sticking of the sealing sheet 105, warpage of the sealing bearing surface 152a for mounting the sealing sheet 105 thereon, and the like.

The waving during the sticking as the first reason is generated due to that when the sealing sheet 105 is stuck to the sealing bearing surface 152a, the sealing sheet 105 is stuck in a state in which the sealing sheet 105 is expanded and contracted in the longitudinal direction. This is caused because a contact portion of the sealing sheet 105 with the developing roller 103 and a sticking portion of the sealing sheet 105 to the sealing bearing surface 152a cannot be pulled in the longitudinal direction with a uniform force.

The warpage of the sealing bearing surface 152a as the second reason is generated when the second development frame is molded, and a material of the second development frame 152 and a length of the sealing bearing surface 152a have the influence thereon. In this embodiment, as the material of the second development frame 152, HIPS (high impact polystyrene) is used. Further, in this embodiment, the image forming apparatus 1 has a constitution in which the image can be formed on an A3-size recording material P. For that reason, the length of the sealing bearing surface 152a in the longitudinal direction is longer than a length of a sealing bearing surface used in an image forming apparatus for an A4-size by about 1.4 times, so that accuracy of a dimension, uniformity, or the like of the sealing bearing surface 152a is not readily ensured, and thus causes occurrence of the warpage or the like.

Thus, the sealing bearing surface 152a to which the sealing sheet 105 for preventing toner leakage from the developing chamber 106 to the outside is desired to be molded with high accuracy.

### <Insert Molding of Frame and Electroconductive Sheet>

Next, image such that the second development frame 152 and the electroconductive sheet 170 (first and second electroconductive sheets 171 and 172) are molded integrally with each other will be described. First, as a method without using an additional injection port described later, a basic method of the image in this embodiment will be described. FIGS. 15 and 16 are schematic sectional views of a metal mold structure of the image in this embodiment. FIGS. 15 and 16 schematically show a cross section corresponding to a cross section substantially perpendicular to the longitudinal direction of the second development frame 152. Further, in FIGS. 15 and 16 show a region corresponding to a part of the second development frame 152.

As shown in parts (a) and (b) of FIG. 15 and pats (a), (b), and (c) of FIG. 16, in this embodiment, a metal mold 200 constituted by including a movable-side metal mold 201 as a first metal mold and a fixing-side metal mold 202 as a second metal mold. Each of the movable-side metal mold 201 and the fixing-side metal mold 202 has a shape providing a shape of the second development frame 152 when the shape thereof is transferred. Further, in this embodiment, the fixing-side metal mold 202 is provided with an injection port (gate, resin injection port) through which a resin is injected.

As shown in part (a) of FIG. 15, in this embodiment, first and second adsorption surfaces 211 and 213 (hatched portions in part (a) of FIG. 15) of the movable-side metal mold 201 are provided with minute air holes. Further, these minute air holes are connected to a suction device (not shown) and then the first and second electroconductive sheets 171 and 172 are sucked, so that the first and second electroconductive sheets 171 and 172 are adsorbed and held by the movable-side metal mold 201 (holding step). From a viewpoint of stability as adsorption, the first and second adsorption surfaces 211 and 213 may desirably be constituted so that and angle formed by a metal mold drawing direction (arrow H direction in part (a) of FIG. 15) and each of the first and second adsorption surfaces 211 and 213 becomes 70° or more (110° or less). In this embodiment, this angle is set to 70°. When the first and second electroconductive sheets 171 and 172 are sucked and held by the movable-side metal mold 201, the movable-side metal mold 201 is moved in a mold clamping direction (arrow H direction in part (a) of FIG. 15) toward the fixing-side metal mold 202, so that a state as shown in part (b) of FIG. 15 is formed. Thus, the first and second electroconductive sheets 171 and 172 are inserted into positions of the metal mold 200 corresponding to positions of the first and second electroconductive sheets 171 and 172 in the second development frame 152.

Thereafter, as shown in parts (a) and (b) of FIG. 16, a resin which is a material of the second development frame 152 is injected into a gap portion (cavity) 203 in the metal mold 200 through the first and second injection ports 221 and 222 (oblique line portion in parts (a) and (b) of FIG. 16). The first and second electroconductive sheets 171 and 172 are molded so that surfaces thereof follow the surface shape of the movable-side metal mold 201 by injection pressure of the resin (molding step). When injection of the resin is ended, suction of the first and second electroconductive sheets 171 and 172 in the movable-side metal mold 201 is stopped (part (b) of FIG. 16).

Thereafter, as shown in part (c) of FIG. 16, the movable-side metal mold 201 is moved in a mold opening direction (arrow K direction in part (c) of FIG. 16) in which the movable-side metal mold 201 is separated from the fixing-side metal mold 202, so that the image in which the first and second electroconductive sheets 171 and 172 are integrally molded with the second development frame 152 is completed.

Incidentally, in this embodiment, the first and second electroconductive sheets 171 and 172 were held and fixed (adsorbed) by the movable-side metal mold 201, but may be held and fixed (adsorbed) by the fixing-side metal mold 202.

Thus, a manufacturing method of the development frame (developer container) 150 includes the holding step of holding the first and second electroconductive sheets 171 and 172 by the metal mold 200. Further, the manufacturing method of the development frame 150 includes the molding step of molding the second development frame (resin frame) 152 in which the first and second electroconductive sheets 171 and 172 are subjected to the image by injecting the resin through the injection ports. Further, the manufacturing method of the development frame 150 may include a welding step of welding the molded second development frame 152 (first resin frame) 152 with the first development frame (second resin frame) 151 for forming a space accommodating the developer in cooperation with the second development frame 152. Incidentally, a manufacturing method of the developing unit (developing device) 140 may be constituted by including the above-described respective steps of manufacturing the development frame 150 and a mounting step of mounting the developing roller 103 and the sealing sheet (sealing member) 105, and the like to the development frame 150.

### <Insert Molding and High-Accuracy Molding of Sealing Bearing Surface>

Next, a method in this embodiment for molding the sealing bearing surface 152a with high accuracy in the image will be described.

As described above, in this embodiment, an angle formed between a first portion 171a of the first electroconductive sheet 171 forming the remaining amount detecting portion 164 and the second electroconductive sheet 172 is 100°. Further, in this embodiment, an angle formed between each of the first and second adsorption surfaces 211 and 213 of the movable-side metal mold 201 for adsorbing the first and second electroconductive sheets 171 and 172, respectively, and the metal mold drawing direction (arrow H direction in FIG. 15) is 70°. For such reasons of the metal mold structure and the like, it is hard to adsorb both the two surfaces of the first portion 171a of the first electroconductive sheet 171 forming the remaining amount detecting portion 164 and the second electroconductive sheet 172 on the movable-side metal mold 201. For that reason, either one of the first electroconductive sheet 171 and the second electroconductive sheet 172 may desirably be disposed over the two surfaces in a direction in which these sheets are arranged. In addition, it is desired that a surface, where the remaining amount detecting portion 164 is not formed, of the electroconductive sheet disposed over the two surfaces is adsorbed on the adsorption surface of the movable-side metal mold 201.

In this embodiment, of the first and second electroconductive sheets 171 and 172, the first electroconductive sheet 171 positioned on a downstream side of the rotational direction of the conveying member 161 is disposed over the two surfaces of the second development frame 152. This is because from a viewpoint such that the remaining amount of the toner in the developing unit 140 (accommodating chamber 107) is detected more accurately. Accordingly, in this embodiment, the first electroconductive sheet 171 includes a second portion (also referred to as “adsorption portion”) 171b which is a portion adsorbed by the metal mold and the first portion (also referred to as “non-adsorption portion”) 171a which is a portion not adsorbed by the metal mold. That is, in this embodiment, when the first electroconductive sheet 171 is held by the movable-side metal mold 201, the first electroconductive sheet 171 is disposed so that the adsorption portion 171b is adsorbed by the first adsorption surface 211 of the movable-side metal mold 201 and so that the non-adsorption portion 171a is not adsorbed by a non-adsorption surface 212 of the movable-side metal mold 201 (parts (a) and (b) of FIG. 15). The first adsorption surface (first surface of the metal mold) 211 and the non-adsorption surface (second surface of the metal mold) 212 are surfaces which are arranged in an arrangement direction of the first and second electroconductive sheets 171 and 172 and which cross each other. Further, when the second electroconductive sheet 172 is held by the movable-side metal mold 201, the second electroconductive sheet 172 is adsorbed by the second adsorption surface 213. The non-adsorption surface (second surface of the metal mold) 212 and the second adsorption surface (third surface of the metal mold) 213 are surfaces which are arranged in the arrangement direction of the first and second electroconductive sheets 171 and 172 and which cross each other.

That is the second adsorption surface 213 is a surface provided adjacently to the non-adsorption surface 212 and crossing the non-adsorption surface 212.

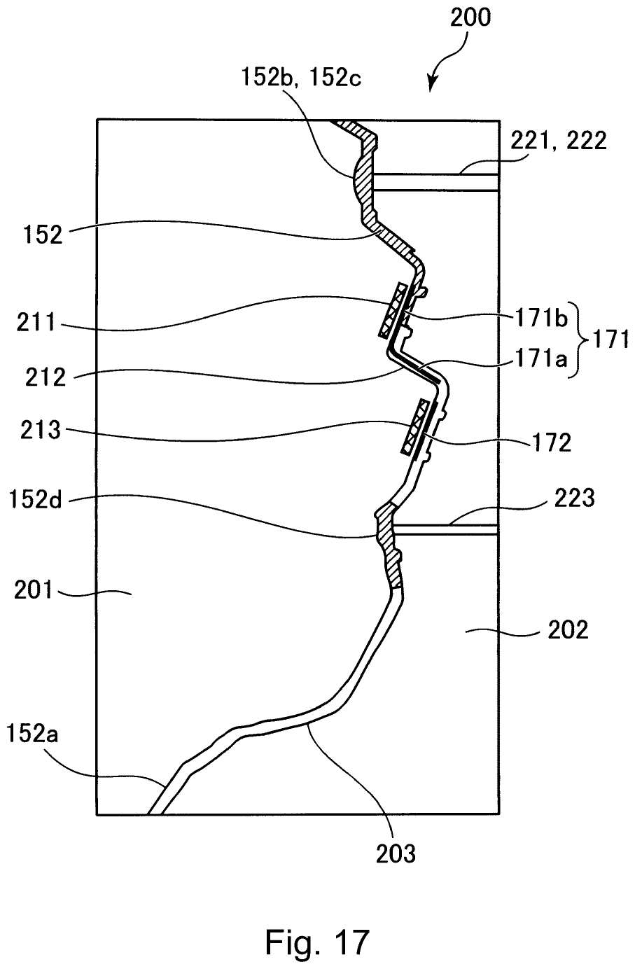

Here, a direction (arrangement direction) in which the first electroconductive sheet 171 and the second electroconductive sheet 172 are arranged in this order is referred to as a “first direction”. This first direction can be said as a cross-sectional direction substantially perpendicular to the longitudinal direction (Y direction) of the second development frame 152. Further, in this embodiment, this first direction can be said as a direction along the gravitational direction (Z2 direction) when the first direction is said based on an attitude of the image forming apparatus 1 (developing unit 140). Further, in FIGS. 15 and 16 (similar in FIG. 17 described later), the first direction corresponds to a direction from above to below in these figures. On the other hand, a direction crossing (perpendicular to) the first direction is referred to as a “second direction”. This second direction corresponds to the longitudinal direction (Y direction). That is, the first electroconductive sheet 171 and the second electroconductive sheet 172 are held by the metal mold 200 so as to be arranged in this order from an upstream side to a downstream side in the first direction. Further, the molded second development frame 152 includes the sealing bearing surface 152a which extends along the second direction perpendicular to the first direction on a side downstream of the second electroconductive sheet 172 with respect to the first direction and to which the sealing sheet 105 is to be mounted.

In the injection molding, the resin injected into the gap portion of the metal mold through the injection port during the molding flows through the injection port toward an end portion of a shape to be molded. Then, in the image (insert injection molding), by resin injection pressure, the surfaces of the first and second electroconductive sheets 171 and 172 are molded so as to follow the surface shape of the movable-side metal mold 201. In this embodiment, the first electroconductive sheet 171 includes the adsorption portion 171b and the non-adsorption portion 171a in this order along the first direction. For that reason, based on the characteristic of the image as described above, it is desirable that the injection ports are disposed so that the resin reaches the first electroconductive sheet 171 from an adsorption portion 171b side in the first direction. Therefore, in this embodiment, the injection port 221 and the second injection port 222 are disposed on a side upstream of the first electroconductive sheet 171 (adsorption portion 171b) with respect to the first direction. Further, in this embodiment, in order to efficiently inject the resin into the gap portion 203 of the metal mold 200 in a wide range in the second direction, the first injection port 221 and the second injection port 222 are arranged and disposed in the second direction. In this embodiment, the first and second injection ports 221 and 222 are disposed in positions corresponding to symmetrical positions on opposite end portion sides relative to a center of the second development frame 152 with respect to the longitudinal direction. Particularly, in this embodiment, the first and second injection ports 221 and 222 are disposed in positions which are the same as positions of opposite ends of the above-described detection range W or positions corresponding to positions where the detection range W falls between the first and second injection ports 221 and 222 (first and second injection port marks 152b and 152c in FIG. 11). Incidentally, in this embodiment, two injection ports consisting of the first and second injection ports 221 and 222 are provided, but the present invention is not limited thereto. Depending on a size or the like of the second development frame 152, on a side upstream of the first electroconductive sheet 171 with respect to the first direction, three or more injection ports may be provided and arranged in the second direction.

On the other hand, when the first and second injection ports 221 and 222 are disposed as described above, the sealing bearing surface 152a disposed in an end portion of the second development frame 152 becomes a positional relationship such that the sealing bearing surface 152a is positioned away from the first and second injection ports 221 and 222. For that reason, accuracy of a dimension, uniformity, and the like of the sealing bearing surface 152a is not readily ensured, so that warpage or the like is liable to occur.

Therefore, in this embodiment, a metal mold structure as described below will be employed. FIG. 17 is a sectional view of a metal mold structure, similar to those of FIGS. 15 and 16, inclusive showing a portion corresponding to the sealing bearing surface 152a. FIG. 17 shows a state in which the resin is injected into the gap portion 203 of the metal mold 200 similarly as in part (a) of FIG. 16 (molding step). Incidentally, as described later, in this embodiment, with respect to the second direction, positions of the first and second injection ports 221 and 222 and a position of the third injection port 223 are different from each other, but in FIG. 17, these injection ports are schematically shown in combination.

As shown in FIG. 17, in this embodiment, in addition to the first and second injection ports 221 and 222, the third injection port 223 is provided in the fixing-side metal mold 202. This third injection port 223 is disposed on a side downstream of the second electroconductive sheet 172 and upstream of a position corresponding to the sealing bearing surface 152a with respect to the first direction. By this, the first and second electroconductive sheets 171 and 172 can be satisfactorily molded so as to follow the surface shape of the metal mold 200 by the resin injected through the first and second injection ports 221 and 222, and in addition, by molding the sealing bearing surface 152a with the resin injected through the third injection port 223 closer to the sealing bearing surface 152a than the first and second injection ports 221 and 222 are, so that the sealing bearing surface 152a is capable of being molded with high accuracy.

Incidentally, the non-adsorption portion 171a of the first electroconductive sheet 171 is not held and fixed (adsorbed) by the movable-side metal mold 201 during the molding (parts (a) and (b) of FIG. 15). For that reason, when the resin injected through the third injection port 223 reaches the non-adsorption portion 171a of the first electroconductive sheet 171 earlier than the resins injected through the first and second injection ports 221 and 222, there is a possibility that the following phenomenon occurs. That is, there is a possibility that it becomes hard to mold the surface of the first electroconductive sheet 171 so as to follow the surface shape of the movable-side metal mold 201. For that reason, the resin injected through the third injection port 223 may preferably be decreased as can as possible. Therefore, in this embodiment, the number of the injection ports disposed on the side downstream of the second electroconductive sheet and upstream of the position corresponding to the sealing bearing surface 152a with respect to the first direction is smaller than the number of the injection ports disposed on the side upstream of the first electroconductive sheet 171 with respect to the first direction. In this embodiment, the former is one which is the third injection ports 223 and the latter is two which are the first and second injection ports 221 and 222, but the present invention is not limited thereto. In the case where three or more injection ports are provided on the side upstream of the first electroconductive sheet 171 with respect to the first direction, two or more injection ports may be provided on the side downstream of the second electroconductive sheet 172 and upstream of the position corresponding to the sealing bearing surface 152a with respect to the first direction.

Further, in place of or in addition to the above-described number setting, an area (opening area) of an injection port flat surface may be changed. In this embodiment, an area of an injection port flat surface of each of the first and second injection ports 221 and 222 is smaller than an area of an injection port flat surface of the third injection port 223.

Further, in this embodiment, in the second direction, the third injection port 223 is disposed between the first injection port 221 and the second injection port 222. Particularly, in this embodiment, the third injection port 223 is disposed is a substantially central portion of the second development frame 152 with respect to the second direction. By this, even when the number of the third injection port 223 is relatively small, the resin can be effectively injected in the second direction through the third injection port 223, so that the sealing bearing surface 152a can be molded with high accuracy. Further, by this, even when the area of the injection port flat surface is relatively small, the resin can be effectively injected in the second direction through the third injection port 223, so that the sealing bearing surface 152a can be molded with high accuracy.

Further, the third injection port 223 may preferably be disposed so as to suppress that the development frame (developer container) 150 (i.e., the developing device 140, the process cartridge 100) is upsized. For example, the third injection port 223 can be disposed in a position (stepped portion) of the metal mold 200 corresponding to the recessed portion formed on the second development frame 152 irrespective of the presence or absence of the third injection port 223. In this embodiment, specifically, the third injection port 223 was disposed in the following position. That is, the third injection port 223 is disposed in a position corresponding to an empty space (recessed portion) generated by a guiding surface 152e provided on the second development frame 152 and constituted by an inclined surface for scooping the toner and by a welding surface 152f provided on the second development frame 152 and welded with the first development frame 151. The guiding surface 152e is a surface which is continuous to the lower surface 163b of the recessed portion 163 provided with the second electroconductive sheet 172 on the above-described front-side inner wall surface 192 and which is for guiding movement of the toner toward the second electroconductive sheet 172 along the Z direction. Further, the welding surface 152f is a surface where an end portion, on the second development frame 152 side, of a portion for forming the partition wall 167 in the first development frame 151 is welded along the longitudinal direction.

Here, on a member such as the second development frame 152 manufactured by the injection molding, injection port marks which are marks where the resin was injected through the injection ports are formed with the resin. For that reason, from the injection port marks on the manufactured member, it is possible to discriminate a positional relationship, sizes, and the like of the injection ports during manufacturing. As shown in FIG. 11, in this embodiment, on the manufactured second development frame 152, first to third injection port marks 152b, 152c, and 152d which are marks where the resin is injected through the first to third injection ports 221, 222, and 223, respectively, are formed. In the positional relationship, sizes, and the like of the first to third injection port marks 152b, 152c, and 152d, the positional relationship, sizes, and the like of the first to third injection ports 221, 222, and 223 during the manufacturing are reflected.

As described above, according to this embodiment, when the electroconductive sheet 170 is provided on the second development frame 152 by the image, the sealing bearing surface 152a to which the sealing sheet 105 is to be mounted can be molded with high accuracy. By this, leakage of the toner from the development frame (developer container) 150 to the outside can be prevented.

### OTHER EMBODIMENTS

In the above, the present invention was described based on a specific embodiment, but the present invention is not limited to the above-described embodiment.

In the above-described embodiment, the image forming apparatus was of the process cartridge type, but the present invention is not limited thereto. The developing device may be fixed to the apparatus main assembly of the image forming apparatus. Further, the developing device may be made detachably mountable to the apparatus main assembly of the image forming apparatus substantially singly. Further, the image forming apparatus may have a constitution in which the developer is capable of being supplied from the supply container to the developing device fixed to or detachably mountable to the apparatus main assembly. In this case, the supply container may be mounted to the developing device during the supply of the developer and then may be demounted from the developing device before the image formation is carried out, or the image formation may be carried out while the supply container is mounted to the developing device as it is.

Further, in the above-described embodiment, the sealing member was the sheet-like member formed of the resin. The sheet-like member formed of the resin is readily influenced by the size and the shape of the sealing bearing surface, and therefore, it can be said that the present invention particularly effectively acts thereon. However, the present invention is not limited thereto. The sealing member is not limited to the sheet-like member, but may be a pad-like member formed with a sponge, a nonwoven fabric, or the like. Further, the sealing member is not limited to that the sealing member is formed of the resin, but the sealing member may be formed of a rubber, paper, metal, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057811 filed on Mar. 29, 2024, which is hereby incorporated by reference herein in its entirety.

What is claimed is:

1. A developing device comprising:
a developing roller;
a resin frame constituting a developer container for accommodating a developer;
a sealing member configured to seal a gap between the developing roller and the resin frame;
a first resin sheet molded integrally with the resin frame and having electroconductivity; and
a second resin sheet molded integrally with the resin frame and having electroconductivity, the second resin sheet being arranged with the first resin sheet in a first direction and being provided on a side downstream of the first resin sheet with respect to the first direction,
wherein the resin frame includes a bearing surface for mounting the sealing member thereon, and a first injection port mark, a second injection port mark, and a third injection port mark which are marks where a resin was injected,
wherein the bearing surface extends in a second direction crossing the first direction on a side downstream of the second resin sheet with respect to the first direction,
wherein the first injection port mark and the second injection port mark are provided on a side upstream of the first resin sheet with respect to the first direction and are arranged in the second direction, and
wherein the third injection port mark is provided on a side downstream of the second resin sheet and upstream of the bearing surface with respect to the first direction.

2. The developing device according to claim 1, wherein the first resin sheet is provided over a first surface and a second surface which are arranged in the first direction and which cross each other.

3. The developing device according to claim 2, wherein the second resin sheet is provided on a third surface which is provided adjacently to the second surface, of the first surface and the second surface, positioned on a downstream side with respect to the first direction and which crosses the second surface.

4. The developing device according to claim 1, wherein the third injection port mark is provided between the first injection port mark and the second injection port mark in the second direction.

5. The developing device according to claim 1, wherein an area of the third injection port mark is narrower than an area of each of the first injection port mark and the second injection port mark.

6. The developing device according to claim 1, wherein in a case where the resin frame is a first resin frame, the developing device comprises a second resin frame configured to form the developer container in cooperation with the first resin frame,
wherein the first resin frame includes a guiding surface configured to guide movement of the developer toward the second resin sheet along the first direction in the developer container, and includes a welding surface welded with the second resin frame, and
wherein the third injection port mark is provided in a recessed portion formed by the guiding surface and the welding surface.

7. The developing device according to claim 1, further comprising an acquiring portion configured to acquire a signal depending on electrostatic capacity between the first resin sheet and the second resin sheet.

8. A developer container manufacturing method for manufacturing a developer container for accommodating a developer, comprising:
a holding step of holding a first resin sheet having electroconductivity and a second resin sheet having electroconductivity on a metal mold so that the first resin sheet and the second resin sheet are arranged in a first direction in a named order from an upstream side to a downstream side; and
a molding step of molding a resin frame by injecting a resin through a first injection port, a second injection port, and a third injection port and then by molding the first resin sheet and the second resin sheet integrally with each other, in which the resin frame includes a bearing surface for mounting a sealing member thereon on a side downstream of the second resin sheet with respect to the first direction, the bearing surface extending along a second direction crossing the first direction,
wherein the first injection port and the second injection port are arranged in the second direction on a side upstream of the first resin sheet with respect to the first direction, and
wherein the third injection port is positioned on a side downstream of the second resin sheet and upstream of a position corresponding to the bearing surface with respect to the first direction.

9. The developer container manufacturing method according to claim 8, wherein in the holding step, the first resin sheet is held on the metal mold so that an upstream-side end portion thereof with respect to the first direction is adsorbed by the metal mold and so that a downstream-side end portion thereof with respect to the first direction is not adsorbed by the metal mold.

10. The developer container manufacturing method according to claim 8, wherein in the holding step, the first resin sheet is disposed over a first surface of the metal mold and a second surface of the metal mold which are arranged in the first direction and which cross each other, and is held on the metal mold so that the first resin sheet is adsorbed on the first surface, of the first surface and the second surface, positioned on an upstream side with respect to the first direction and is not adsorbed on the second surface.

11. The developer container manufacturing method according to claim 10, wherein in the holding step, the second resin sheet is disposed on the third surface which is provided adjacently to the second surface of the metal mold and which crosses the second surface, and is held on the metal mold by being adsorbed on the third surface.

12. The developer container manufacturing method according to claim 8, wherein the third injection port is positioned between the first injection port and the second injection port with respect to the second direction.

13. The developer container manufacturing method according to claim 8, wherein in the molding step, the resin is injected through the third injection port smaller in area than each of the first injection port and the second injection port.

14. The developer container manufacturing method according to claim 8, wherein in a case where the resin frame is a first resin frame, the developer container manufacturing method further comprising:
a welding step of welding a second resin frame for forming the developer container in cooperation with the first resin frame.

15. The developer container manufacturing method according to claim 14, wherein the third injection port is positioned in a stepped portion formed by a surface molding a surface for guiding movement of the developer toward the second resin sheet along the first direction in the developer container and by a surface molding a welding surface on which the second resin frame is welded in the welding step.
